(19) United States
(12) Patent Application Publication
(10) Pub. No.: US 2015/0372717 A1
(43) Pub. Date: Dec. 24, 2015

(54) SLOTTED MESSAGE ACCESS PROTOCOL FOR POWERLINE COMMUNICATION NETWORKS

(71) Applicant: QUALCOMM Incorporated, San Diego, CA (US)

(72) Inventors: Sidney Brower Schrum, JR., Ocala, FL (US); Lawrence Winston Yonge, III, Summerfield, FL (US); Srinivas Katar, Fremont, CA (US); Hao Zhu, Milpitas, CA (US)

(21) Appl. No.: 14/742,665

(22) Filed: Jun. 17, 2015

Related U.S. Application Data
(60) Provisional application No. 62/014,006, filed on Jun. 18, 2014.

(51) Int. Cl. H04B 3/54; H04L 5/00; H04L 12/24

(52) U.S. Cl. CPC H04B 3/542; H04L 41/12; H04L 5/003

(57) ABSTRACT

A slotted message access protocol can be implemented for transmitting messages in a communication network. A beacon period may be divided into multiple communication slots. A master device may register a client device and provide registration information to allow the client device to operate in the communication network. The registration information may be determined based, at least in part, on a location of the client device in the communication network. As part of the registration information, contention-free communication slots may be assigned for use by the client device. Contention-based communication slots may also be assigned to a group of client devices. Messages may also be segmented depending on whether the message is transmitted in a contention-free or a contention-based communication slot. Furthermore, a relay device may be designated to retransmit a message (received from an original transmitting device) during a communication slot assigned to the original transmitting device.

### RELATED APPLICATION

This application claims the priority benefit of U.S. Provisional Application Ser. No. 62/014,006 filed on Jun. 18, 2014.

### BACKGROUND

Embodiments of the disclosure generally relate to the field of communication networks and, more particularly, to a slotted message access protocol for powerline communication (PLC) networks.

Various types of vehicles, such as automobiles, typically include a collection of electric wires that provide communication signals or electrical power between components of the vehicle. The collection of electric wires in the vehicle may also include wires to implement low-rate data buses, such as a local interconnect network (LIN) bus and a controller area network (CAN) bus for intra-vehicular communications. However. LIN and CAN buses introduce additional wires and complex wiring harnesses into the vehicles, thus are typically undesirable to use for data communications.

Powerline communication allows electric power lines to be used as a communication medium to connect various network nodes in local and wide area networks, in addition to distributing and conducting electric power. Since vehicles typically have an existing power distribution infrastructure, the existing power lines can be utilized for data communications and for connecting components of the vehicle to each other and to the Internet. However, vehicular communication systems typically have stringent latency and reliability requirements that are not supported by current PLC protocols such as those specified by the IEEE 1901 standards and the HomePlug AV/AV2/GreenPHY standards for broadband over powerline communication.

### SUMMARY

Various embodiments of a slotted message access protocol are described. In one embodiment, a first network device determines to register a second network device in a communication network. The first network device determines a location of the second network device based, at least in part, on a first message received from the second network device. The first network device determines registration information for the second network device based, at least in part, on the location of the second network device in the communication network.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram including a mechanism for implementing S-MAP to transmit messages in a communication network;

FIG. 2 is an example block diagram including a mechanism for transmitting a message between network devices of a vehicle;

FIG. 3 is a flow diagram illustrating example operations for a master network device to register a client network device in a communication network;

FIG. 4 is a flow diagram illustrating example operations for a master network device to register a client network device in a communication network;

FIG. 5 is a flow diagram illustrating example operations for a client network device to register with a master network device of a communication network;

FIG. 6A depicts an example format of a physical layer protocol data unit (PPM);

FIG. 6B depicts one example of a medium access control protocol data unit (MPDU) format;

FIG. 6C depicts another example of an MPDU format;

FIG. 7 is a flow diagram illustrating example operations of a master network device allocating communication slots for contention-free access of the communication medium;

FIG. 8 is an example slot allocation schedule illustrating assignment of contention-free communication slots;

FIG. 9 is a flow diagram illustrating example operations of a client network device for contention-based access of a communication medium;

FIG. 10 is a timing diagram illustrating an example mechanism for contending for control of a contention-based communication slot;

FIG. 11 is a flow diagram illustrating example operations for transmitting segmented messages;

FIG. 12 is a flow diagram illustrating example operations for receiving and assembling segmented messages;

FIG. 13 is a flow diagram illustrating example operations for relaying messages in a communication network;

FIG. 14 is a is an example conceptual diagram illustrating an original transmission and retransmissions by relay devices; and

FIG. 15 is a block diagram of one embodiment of an electronic device including a slot allocation mechanism for transmitting messages.

### DESCRIPTION OF EMBODIMENT(S)

The description that follows includes exemplary systems, methods, techniques, instruction sequences, and computer program products that describe various embodiments of the present disclosure. However, it is understood that the described embodiments may be practiced without specific details disclosed. For example, although some embodiments describe transmitting messages in a PLC network using HomePlug® AV/AV2/GreenPHY or IEEE 1901 communication protocols, the operations described herein can be extended to other wired communication protocols (e.g., multimedia over coax alliance (MoCA) protocols, Ethernet protocols, etc.) or wireless communication protocols (e.g., wireless local area network (WLAN) protocols such as IEEE 802.11 protocols). In other instances, well-known instruction instances, protocols, structures, and techniques have not been shown in detail in order not to obfuscate the description.

A powerline network is a shared communication network in which multiple network devices are coupled to the powerline medium. In addition to providing electric power, the powerline medium may also facilitate communications between PLC devices, such as between network devices of a PLC network within a vehicle. In some embodiments, the vehicle may be configured to use PLC protocols HomePlug AV/AV2/GreenPHY protocols, IEEE 1901 protocols, etc) for inter-vehicular communications and intra-vehicular communications. Using PLC protocols for communication can minimize the complexity of wiring harnesses and eliminate or reduce the need for additional data buses (e.g., a LIN bus and a CAN bus) in the vehicle.

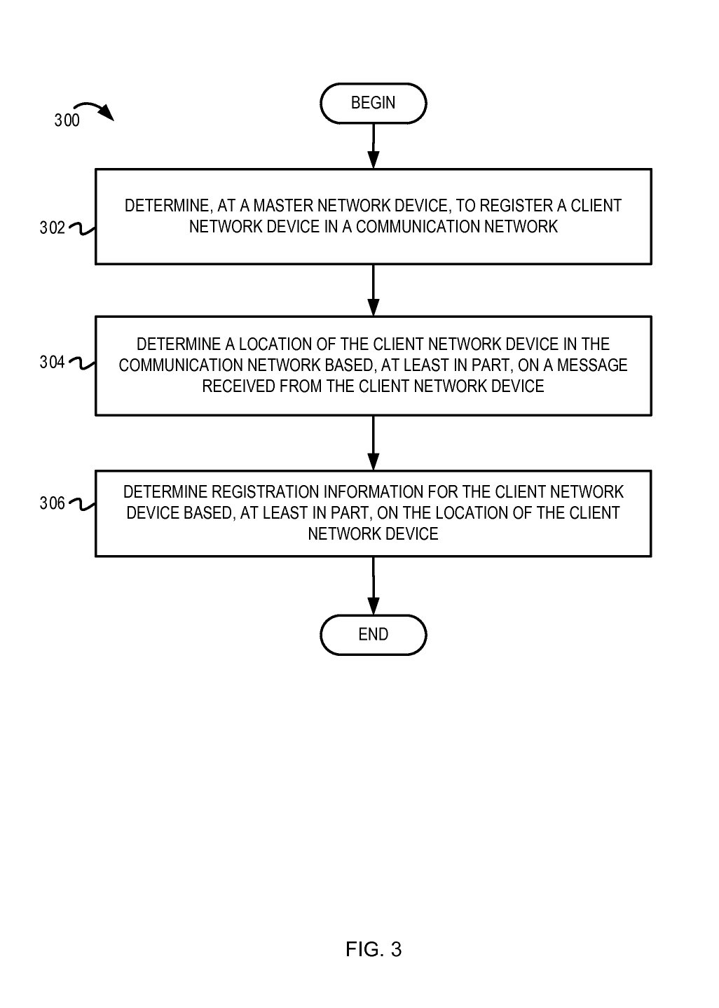

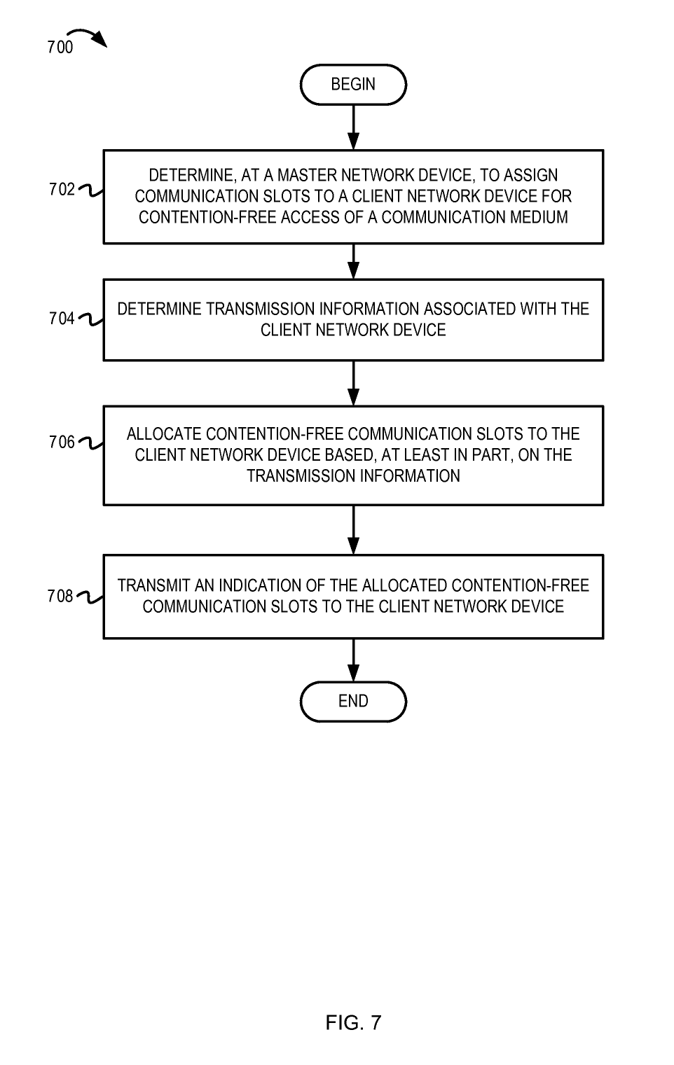

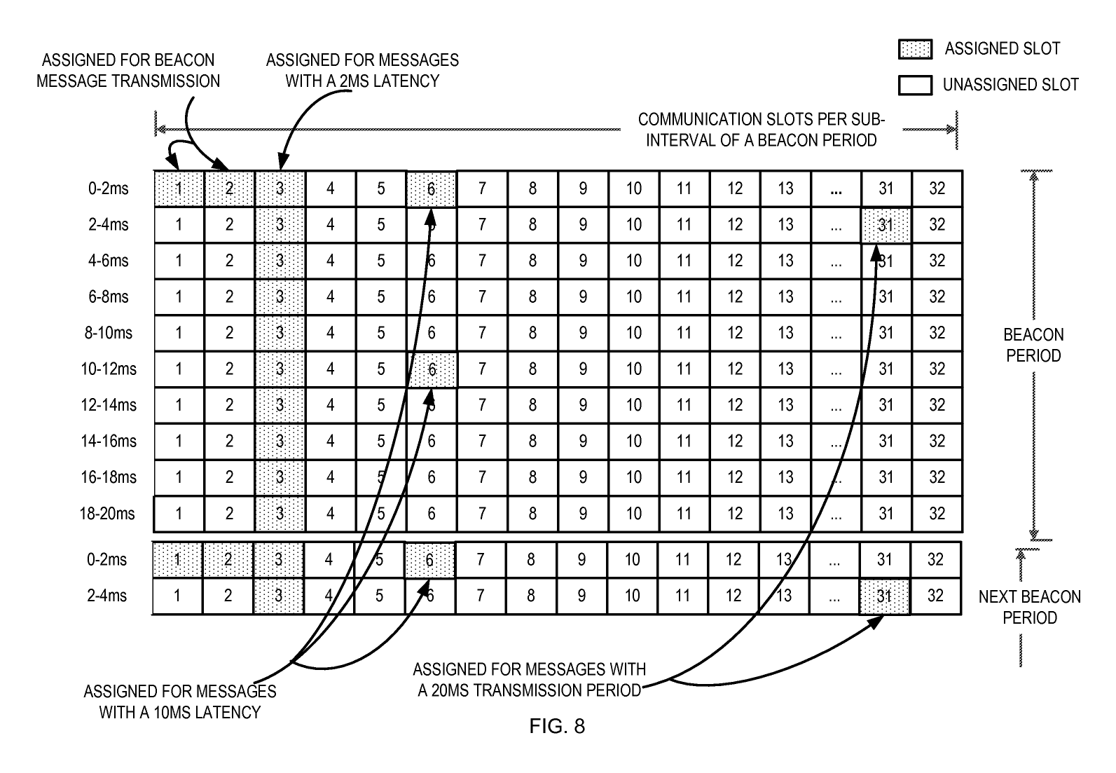

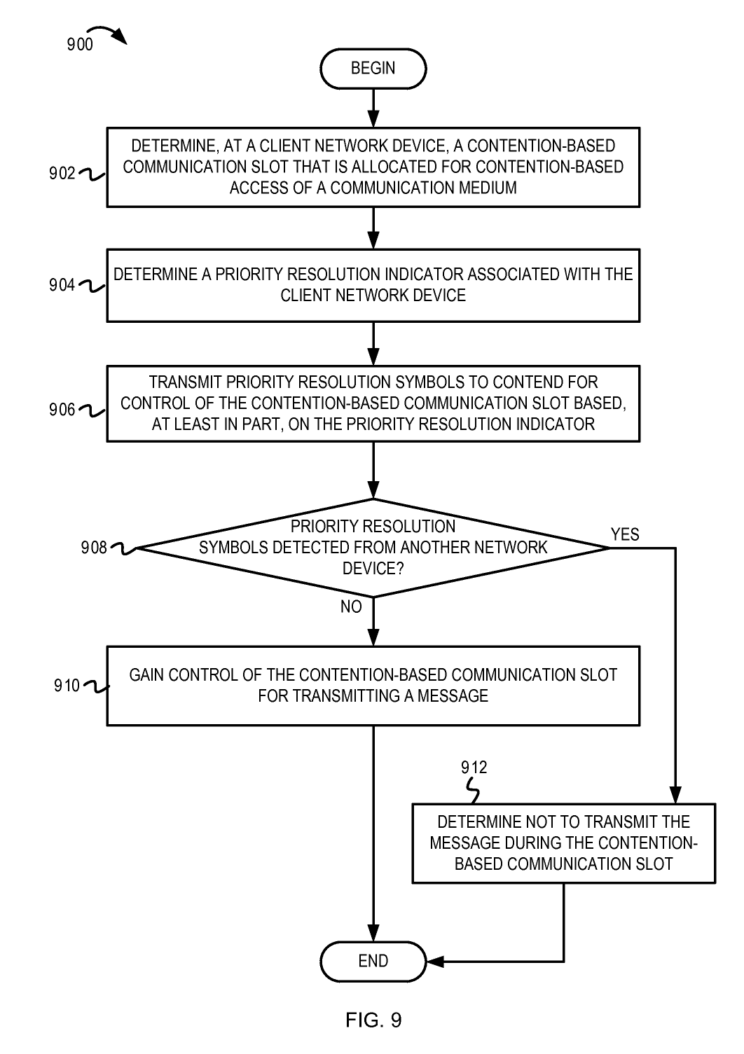

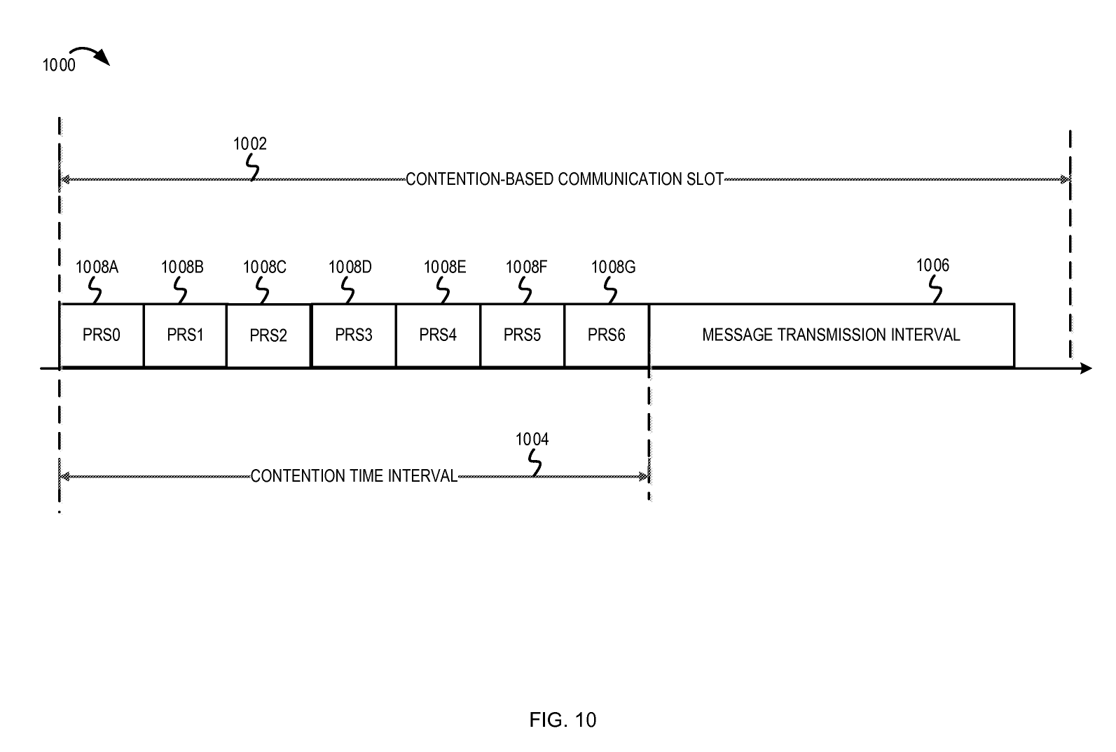

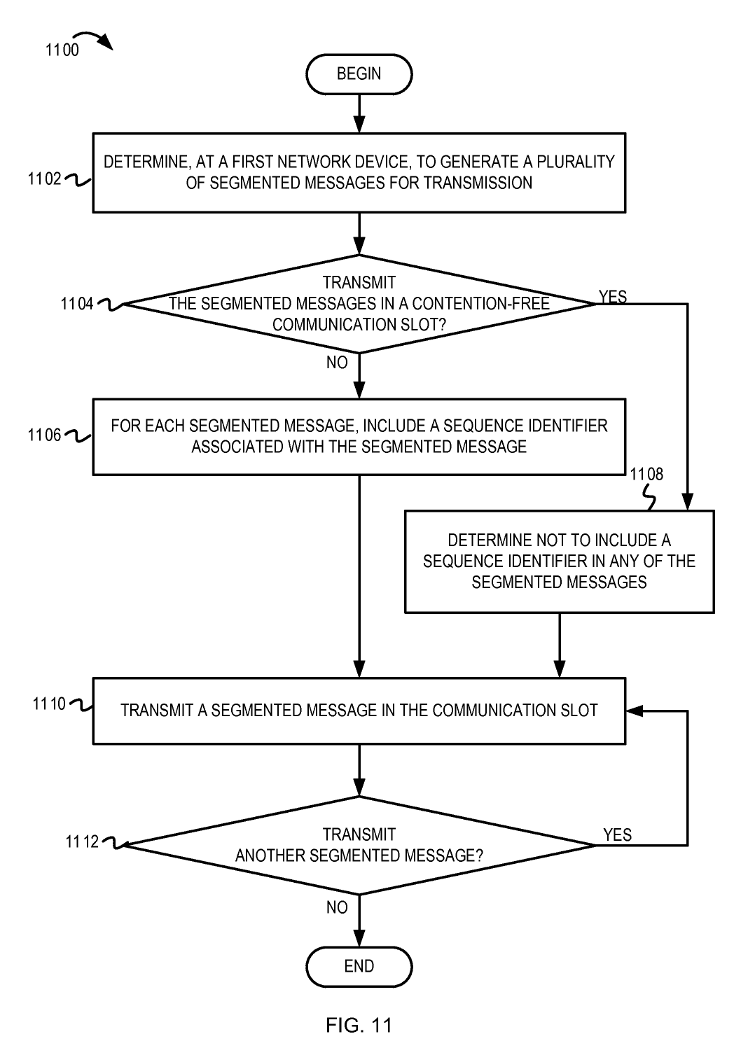

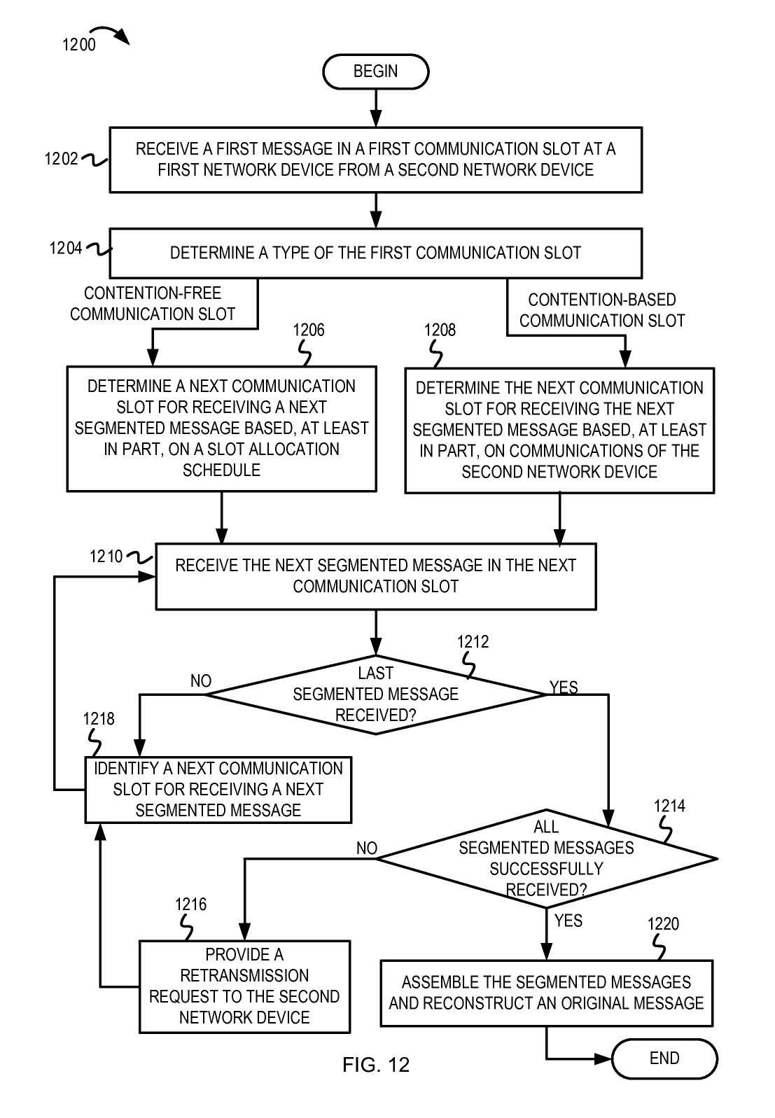

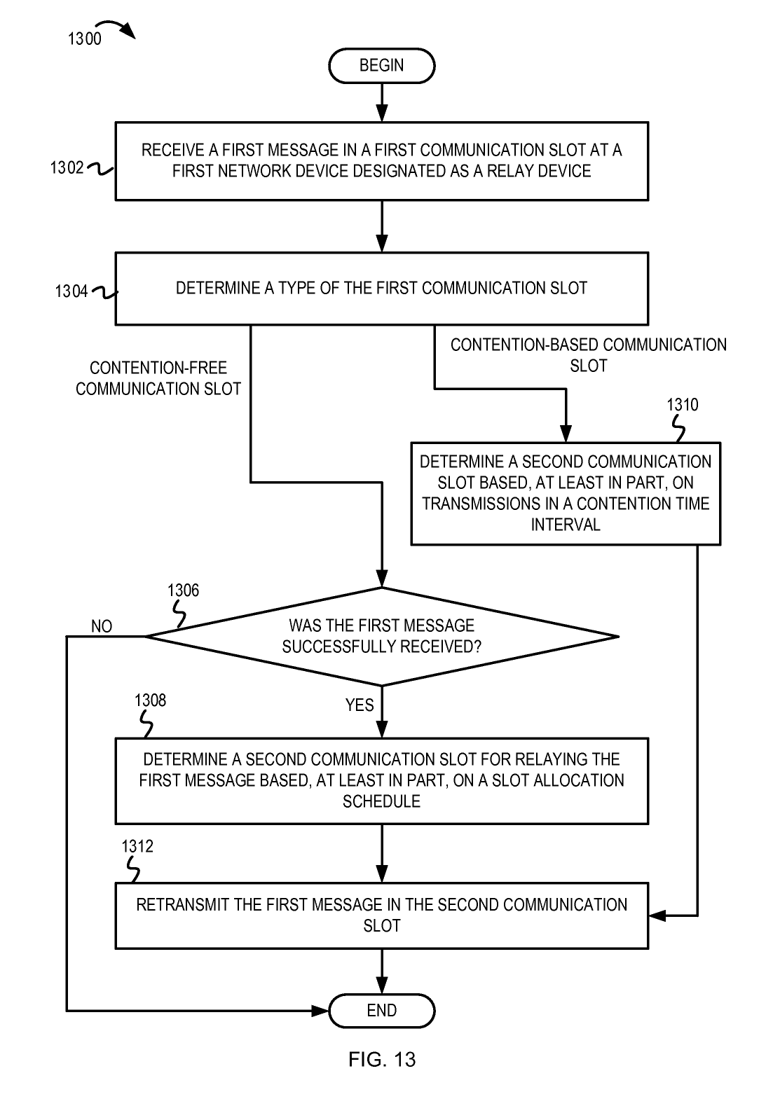

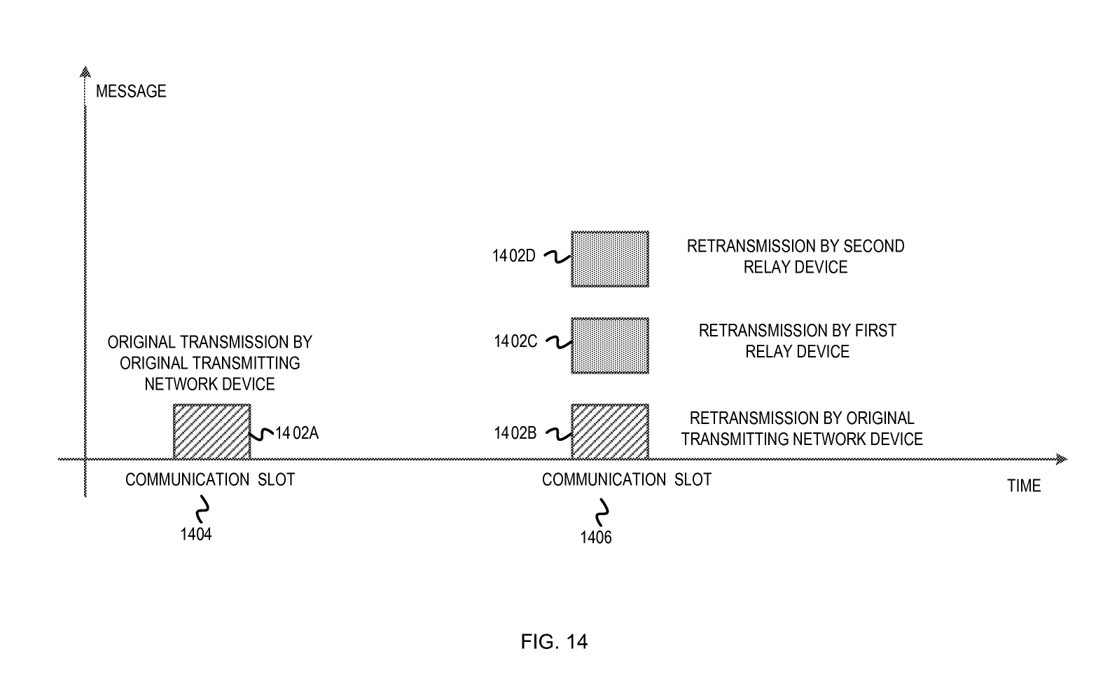

In some embodiments, a network device is configured to implement a slotted message access protocol (S-MAP) to efficiently transmit messages in a communication network. In S-MAP, the transmission time on a communication medium (“time-on-wire”) may be divided into communication slots (also referred to as “communication time slots” or “S-MAP slots”). A master network device may register a client network device in the communication network to implement S-MAP. As part of the registration operations, the master network device may distinguish between different client network devices (e.g., in terms of a device identifier and location in the communication network) for subsequent communication with the client network devices. Additional disclosure regarding the registration operations will be described with reference to FIGS. 3-5. The master network device may assign communication slots to a client network device depending on different types of messages that will be transmitted by the client network device. Collision-free transmissions may be performed in contention-free communication slots by assigning different communication slots to the client network devices, as will be described in FIGS. 7 and 8. Additionally, some communication slots may be designated as contention-based communication slots. Client network devices may contend for the opportunity to transmit messages during the contention-based communication slots based, at least in part, on a priority associated with each contending network device, as will be further described in FIGS. 9 and 10. The client network devices may also execute different operations for segmenting messages (described in FIGS. 11 and 12) and relaying messages (described in FIGS. 13 and 14) depending on the communication slot in which the message is transmitted/received. Adapting existing communication protocols to transmit messages during assigned communication slots can minimize overhead and message collisions, and improve communication efficiency and reliability.

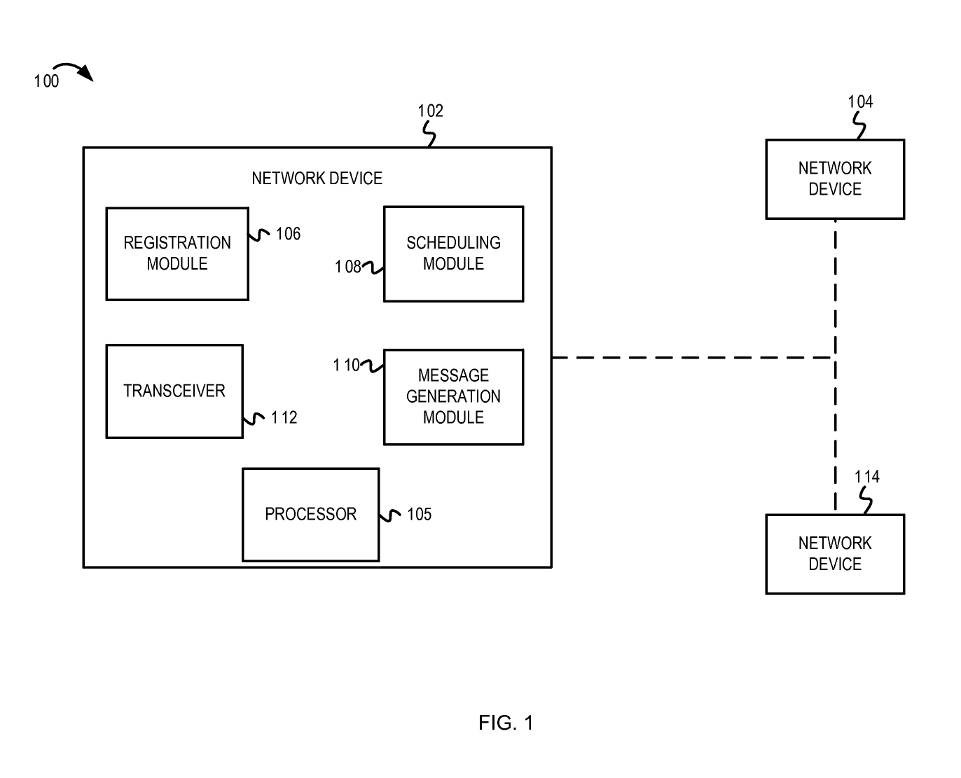

FIG. 1 is an example block diagram including a mechanism for implementing S-MAP to transmit messages in a communication network 100. The communication network 100 includes network devices 102, 104, and 114. The network device 102 includes a processor 105, a registration module 106, a scheduling module 108, a message generation module 110, and a transceiver 112. Although not shown in FIG. 1 for simplicity, the network devices 104 and 114 may also include a processor, a registration module, a scheduling module, a message generation module, and/or a transceiver. The network devices 102, 104, and 114 may be communicatively coupled with each other using wired and/or wireless communication links, depicted in FIG. 1 using dashed lines. The network devices 102, 104, and 114 may communicate during communication slots that are allocated using S-MAP, as will be further described below.

In one embodiment, the communication network 100 is a PLC network and the network devices 102, 104, and 114 are PLC-capable devices. The network devices 102, 104, and 114 may operate using a HomePlug 1.0/AV/AV2/GreenPHY communication protocol, an IEEE 1901 communication protocol, an IEEE 1905 communication protocol, and/or another suitable PLC protocol. In addition to (or instead of) the PLC protocol, the network devices 102, 104, and 114 may implement other suitable wired communication protocols (e.g., Ethernet protocols, MoCA protocols, etc.) and/or wireless communication protocols (e.g., WLAN protocols, such as IEEE 802.11 protocols).

In one embodiment, the network device 102 is a master network device and the network devices 104 and 114 are client network devices. In other embodiments, any one of the network devices 102, 104, and 114 can be the master network device and the remaining network devices can be the client network devices. In some embodiments, the registration module 106 includes instructions that, when executed by the processor 105, register a client network device and provide registration information to a client network device. The registration information can include a device identifier of the client network device, encryption keys for transmitting and receiving messages, communication slots for transmitting and receiving messages, and so on. The registration module 106 may also execute location resolution operations to provide registration information to each client network device in the communication network 100. In some embodiments, the registration module 106 includes instructions that, when executed by the processor 105, exchange various registration messages with a master network device and receive registration information from the master network device that is used for subsequent communication. Although examples describe the master network device registering a client network device, in other embodiments, a registered client network device may be configured to register an unregistered client network device in the communication network. The registration operations will be further described in FIGS. 3-5.

In some embodiments, the scheduling module 108 includes instructions that, when executed by the processor 105, allocate communication slots for contention-free access and/or contention-based access of the communication medium. The communication slots that are allocated for contention-free access may also be referred to as “contention-free communication slots.” The communication slots that are allocated for contention-based access may also be referred to as “contention-based communication slots.” The scheduling module 108 may allocate the communication slots based on certain parameters (e.g., number, type, frequency, and/or latency) relating to messages that will be transmitted by the client network device. The scheduling module 108 may allocate the communication slots as part of the registration operations or after the registration operations are completed. Operations for allocating communication slots will be described in FIGS. 7-9.

In some embodiments, the scheduling module 108 includes instructions that, when executed by the processor 105, perform priority resolution and contend with other network devices for control of the contention-based communication slot prior to transmitting messages in a contention-based communication slot. The scheduling module 108 can transmit a message during the contention-based communication slot after gaining control of the contention-based communication slot, as will be described in FIGS. 9 and 10.

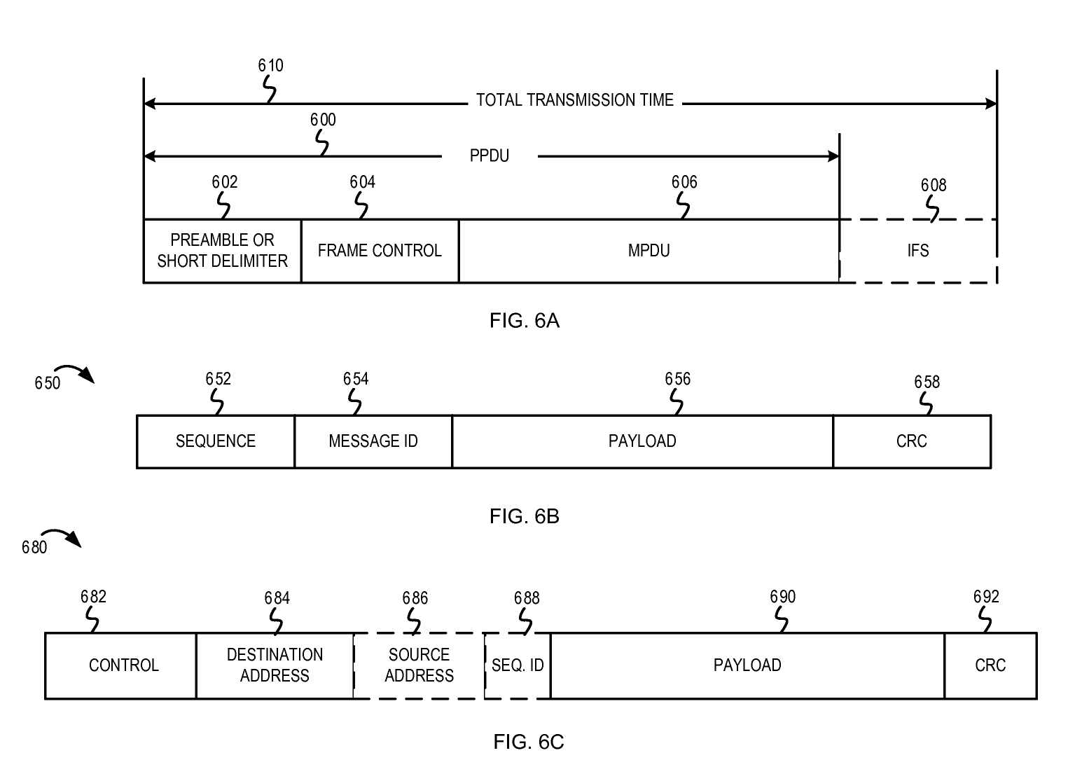

In some embodiments, the message generation module 110 includes instructions that, when executed by the processor 105, determine a suitable message format (described in FIGS. 6A-6C) for transmitting data in the communication network. The message generation module 110 may use the selected message format to generate a message for transmission during a communication slot assigned to the network device. For example, the message generation module 110 may generate a message using a short message format to transmit a short payload via an automotive bus to control certain functions in a vehicle (e.g., to control a vehicle entertainment system, open/close doors, adjust vehicle mirrors, and so on). A short payload is a payload that has a length that is less than or equal to a threshold payload length. The threshold payload length may be a threshold number of bytes. In one example, a short payload is a payload that has less than or equal to 12 bytes. It is noted that a message may generally refer to a physical layer protocol data unit (PPDU), a medium access control (MAC) protocol data unit (MPDU), a frame, or a packet. For example, as described further below, the message may be a PLC PPDU for HomePlug communication protocols. Additionally, if the data cannot be transmitted in a single message, the message generation module 110 may generate two or more segmented messages from an original message for transmission. In a receiving network device, the message generation module 110 may reconstruct the original message from received segmented messages. Operations for segmenting messages will be described in FIGS. 11 and 12. Additionally, if the client network device is designated as a relay device, the scheduling module 108 may retransmit messages received from an original transmitting network device. The scheduling module 108 may determine whether and when to relay messages based, at least in part, on registration information provided by the master network device. Operations for relaying messages will be described in FIGS. 13 and 14.

The transceiver 112 may include a receiver and a transmitter. The receiver and the transmitter may be implemented on the same integrated circuit (IC), as separate components on the same chip, or as separate components on different chips. The receiver may include an analog front end (AFE) that includes an amplifier to amplify received signals, a filter to remove unwanted frequencies from the received signals, a mixer to down-convert the received signal, an automatic gain control (AGC) module, and an analog-to-digital converter (ADC). The receiver may also include a fast Fourier transform (FFT) module to convert the received signal from a time domain representation to a frequency domain representation and/or a decryption and decoding module. The transmitter may include an AFE that includes an amplifier to amplify signals to be transmitted, a filter to remove unwanted frequencies from the signals to be transmitted, a mixer to up-convert the signal to an appropriate transmission frequency, and a digital-to-analog converter (DAC). The transmitter may also include an inverse fast Fourier transform (IFFT) module to convert the signal to be transmitted from a frequency domain representation to a time domain representation and/or an encryption and encoding module.

In some embodiments, the network devices 102, 104, and 114 are electronic devices, such as a desktop computer, a laptop computer, a tablet computer, a mobile phone, a smart appliance, a navigation device, a media player, a gaming console, a network bridging device, an access point, or other electronic devices that implement wired and/or wireless communication protocols. One or more of the network devices 102, 104, and 114 may be a standalone or dedicated PLC device that directly connects to an alternating current (AC) outlet (not shown) of a PLC network. In some embodiments, the network devices 102, 104, and 114 are part of a communication network of a vehicle, machinery, or other electronic system.

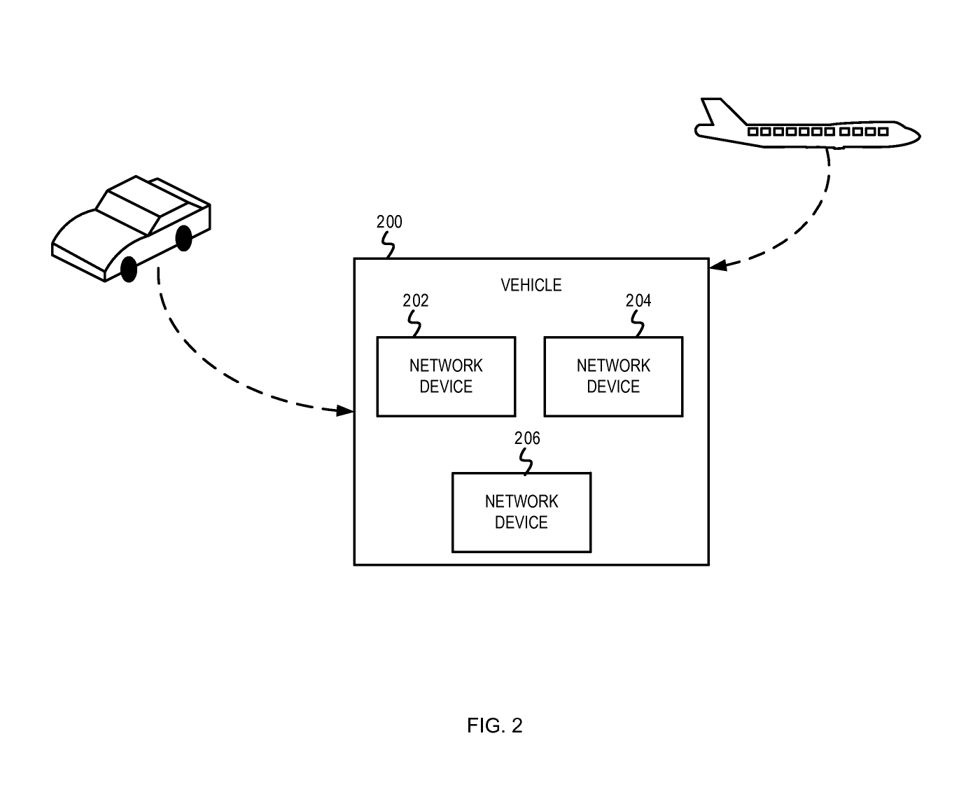

The communication network 100 can be implemented in a vehicle 200 as depicted in FIG. 2. The vehicle 200 includes network devices 202, 204, and 206. The network devices 202, 204, and 206 may be configured similarly to the network device 102 of FIG. 1. The vehicle 200 may be an electric vehicle, a plug-in electric vehicle (PEV), a hybrid electric vehicle, a gas-powered vehicle, an aircraft, etc. The network devices 202, 204, and 206 may be electronic devices/components of the vehicle 200, such as the vehicle's central computer, heating and cooling system components, charging and battery system components, entertainment devices, security system components (e.g., windows, door locks, alarm, etc.), and/or other suitable electronic devices/components. The network devices 202, 204, and 206 can implement S-MAP for internal communications within the vehicle 200 via an automotive bus. For example, the network devices 202, 204, and 206 can implement S-MAP to control various operations of a vehicle, such as adjusting vehicle mirrors, opening/closing vehicle doors, switching ON/OFF lights on the vehicle, etc. The automotive bus may be a PLC medium (i.e., electric wires) that couples the network devices 202, 204, and 206 within the vehicle 200. Although FIG. 2 depicts the vehicle 200 including three network devices 202, 204, and 206, the vehicle 200 may include any suitable number of network devices configured to implement S-MAP.

S-MAP may be a time domain multiple access (TDMA) based protocol that divides transmission time on the communication medium into communication slots. In some embodiments, a beacon period may be divided into multiple communication slots as depicted with reference to FIG. 8. The number of communication slots within the beacon period may be determined based, at least in part, on the communication protocol that is being implemented or may be configurable. For example, the beacon period may be 33.3 ms when the HomePlug GreenPHY communication protocol is implemented. In another example, the beacon period may be configured to be 20 ms. In this example, the beacon period is divided into 320 communication slots, each communication slot having a duration of 62.5 μs. Although the example describes each communication slot of a beacon period having the same duration, some/all the communication slot of the beacon period may have a different duration. The master network device (also referred to as “coordinating network device”) may designate one or more of the communication slots per beacon period for transmitting a beacon message. The one or more communication slots per beacon period that are selected for transmitting the beacon message may be referred to as a “beacon allocation.” The beacon message may be transmitted at the beginning of a beacon period or any suitable number of communication slots located in other suitable positions in the beacon period (e.g., middle of the beacon period, end of the beacon period, etc.).

In some embodiments, the master network device transmits a beacon message every beacon period in reference to a local physical layer (PHY) clock associated with the master network device. The beacon message may provide a timing reference so that client network devices can estimate the start/stop time instants of their respective communication slots. A client network device (also referred to as a “slave network device”) may synchronize its local PHY transmit/receive clocks to the PHY clock of the master network device based on time instants (“receive beacon arrival time”) at which the client network device receives beacon messages from the master network device. The client network device may use multiple instances of beacon message reception to estimate the timing difference at the client network device and to synchronize its local PHY clocks with the PHY clock of the master network device. To enable PHY clock synchronization at the client network device, the master network device may derive the time instant for transmitting the beacon message and the PHY clock timing from the same clock at the master network device.

The master network device may assign one or more adjacent communication slots of the beacon period to client network devices to allow the client network devices to transmit management or data messages. The data messages may be application data messages. In some embodiments, multiple adjacent communication slots are allocated to a client network device per beacon period. The communication slots that are allocated to a client network device may be referred to as “medium access allocations.” In other embodiments, the communication slots that are allocated to a client network device in a beacon period may not be contiguous. A beacon period may be associated with an identifier (e.g., a beacon period number). The master network device may select the beacon period identifier and indicate the beacon period identifier in the beacon message. For example, the master network device may select a beacon period identifier at start-up and increment the beacon period identifier for each subsequent beacon period. The beacon period identifier may be randomly selected, predetermined, or selected based on certain criteria. Additionally, the communication slots within the beacon period may also be associated with communication slot identifiers. The master network device may assign a subset of the communication slots per beacon period to a client network device (or to groups of client network devices) in the communication network as will be further described in FIGS. 7-10. Alternatively, the master network device may assign one or more communication slots to a client network device once every N beacon periods. Communication slots that are not assigned to any client network device may be reserved for dynamic slot allocation or for future allocation to client network devices (e.g., plug-and-play devices that connect to the vehicle).

The master network device may generate a slot allocation schedule (also referred to as an S-MAP schedule). The slot allocation schedule can indicate communication slots assigned to the network devices (or groups of network devices), the type of messages that can be transmitted in each communication slot, the class of traffic (“traffic class”) that can be transmitted in each communication slot, and/or the medium access techniques that should be employed for communicating in each communication slot. The type of message may refer to the content of the message, such as whether the message is a heating and cooling system control and/or status message, charging and battery control and/or status message, entertainment device control and/or status message, security system control and/or status message, etc. The slot allocation schedule may also indicate which communication slots are assigned for repeating/relaying messages. In some embodiments, the master network device transmits the slot allocation schedule in a beacon message or in a broadcast management message to registered client network devices in the communication network. In some embodiments, the master network device transmits in a unicast message to a client network device a portion of the slot allocation schedule that is relevant to the client network device. The portion of the slot allocation schedule may indicate when the client network device can transmit different types/classes of messages and when the client network device should listen for messages. The master network device may wait for an acknowledgement message (e.g., an application level acknowledgement message) in response to transmitting the unicast message including the portion of the slot allocation schedule to the client network device. The master network device may retransmit the unicast message if the acknowledgement message is not received within a timeout interval.

The master network device may also transmit slot allocation schedule updates after the master network device registers a client network device. The master network device may periodically update the slot allocation schedule (e.g., every X hours, every Y days, etc.). The master network device may also update the slot allocation schedule if the configuration of a client network device changes, if a client network device is added to or removed from the communication network, and/or if a component or feature is added/removed from the vehicle. The client network devices may use the slot allocation schedule to determine when to initiate their respective transmissions and when to listen for transmissions from other client network devices.

The master network device may provide a wake/sleep schedule to a registered client network device. In some embodiments, the client network devices determine their respective wake/sleep schedule based, at least in part, on the slot allocation schedule provided by the master network device. For example, the client network devices may operate in the active operating state in the communication slots allocated for transmitting/receiving relevant messages (as indicated in the slot allocation schedule). The client network device may determine the wake/sleep schedule based, at least in part, on the portion of the slot allocation schedule received in a unicast message from the master network device. For example, the client network device may remain in the active operating state only during the communication slots allocated for receiving messages and for transmitting messages (when the client network devices has messages to transmit). In some embodiments, the master network device transmits a separate wake/sleep schedule that is separate from the slot allocation schedule. The wake/sleep schedule may indicate the communication slots in a beacon period during which the client network device should operate in the active operating state to transmit or receive messages. The client network device may transition to a low power operating state or a “sleep operating state” during the communication slots when the client network device is not scheduled to transmit/receive messages. During the sleep operating state, the client network device may disable one or more components or configure one or more components in a low power operating state. The client network devices may not receive any messages when configured in the sleep operating state. If the client network device is not scheduled to transmit/receive messages for extended periods of time (e.g., multiple beacon periods), the client network device may transition to a “deep sleep” (or inactive) operating state. A majority of the communication and/or processing components of the client network device may be disabled in the deep sleep operating state. The sleep operating state may be an intermediate operating state between the active operating state and the deep sleep operating state. The time to transition from the sleep operating state to the active operating state may be shorter than the time to transition from the deep sleep operating state to the active operating state. Furthermore, the master network device may optimize the slot allocation schedule and the wake/sleep schedule to maximize the amount of time that each client network device is configured in the sleep operating state to minimize power consumption in the communication network. In some implementations, the master network device may selectively place the entire communication network (e.g., the automotive bus of a vehicle) in a deep sleep operating state. All communications in the communication network may cease for multiple beacon periods when the entire communication network is in the deep sleep operating state.

In addition to generating and distributing the wake/sleep schedule and the slot allocation schedule, the master network device may also register a client network device in the communication network, assign device identifiers (e.g., terminal equipment identifier or TEI) to the registered client network device, and distribute one or more encryption keys to the registered client network device. A client network device may register with the master network device before transmitting messages (e.g., data) in the communication network. As part of the registration operations, the master network device may also distinguish between different client network devices. In contrast to a LIN/CAN bus where client network devices are interconnected in a daisy-chain, client network devices on a PLC automotive bus may be randomly distributed. For example, a vehicle may include multiple lighting modules, each of which is connected at different points in the communication network. This can make it difficult for the master network device to distinguish between these client network devices, especially when the client network devices have the same functionality and/or the same device information. Registration operations of the master network device and the client network device will be further described in FIGS. 3-5.

FIG. 3 is a flow diagram (“flow”) 300 illustrating example operations for a master network device to register a client network device in a communication network. The flow 300 begins at block 302.

At block 302, a master network device determines to register a client network device in a communication network. In some embodiments, the master network device (e.g., a first network device) initiates registration operations to register the client network device (e.g., a second network device) in response to receiving a registration request from the client network device or receiving a user input. In another embodiment, the master network device performs the registration operations during the manufacturing process. The flow continues at block 304.

At block 304, the master network device determines the location of the client network device in the communication network based, at least in part, on a message received from the client network device. In some embodiments, the master network device initiates location resolution operations if more than one client network device has the same device information. The master network device may determine the location of the client network device as part of the location resolution operations. In other embodiments, the master network device determines the location of the client network device irrespective of the whether multiple client network devices have the same device information. In some embodiments, the master network device determines channel characteristics associated with the second network device based, at least in part, on the message received from the client network device. The master network device then uses the channel characteristics to estimate the location of the client network device in the communication network. In other embodiments, the client network device determines its own location in the communication network and transmits a message to the master network device that includes an indication of the location of the client network.

The master network device may employ various techniques to determine the channel characteristics that can be used to estimate the location of the client network device. In some embodiments, the master network device may request the client network device to transmit test messages in the communication network. The master network device and other receiving client network devices may receive the test messages and estimate channel characteristics based, at least in part, on the test messages. The channel characteristics can refer to signal attenuation, signal-to-noise ratio (SNR), and/or link margin of a communication link between 1) the transmitting client network device and a receiving client network device, or 2) the transmitting client network device and the master network device. Propagation delay may also be used to estimate the distance between two client network devices or between the master network device and a client network device. For example, the propagation delay may be estimated from the round-trip delay between the network devices. It is noted that other suitable techniques instead of (or in addition to) round-trip delay may be used to estimate the propagation delay. Furthermore, the channel characteristics (e.g., signal attenuation or phase shift) may be determined for a subset of communication frequencies of the communication channel. For example, the master network device may request the client network device to transmit a test message on one or more communication frequencies. A receiving client network device may transmit a reporting message to the master network device that indicates the channel characteristics determined by the receiving client network device. The master network device may estimate the location of the client network device based, at least in part, on the channel characteristics determined by the master network device and the channel characteristics reported by other client network devices.

Additionally, the master network device may transmit a control message to cause one or more client network devices to selectively “short” or “load” the powerline wiring prior to the client network device transmitting the test messages. Shorting or loading the powerline wiring can alter the characteristics of the communication channel between the network devices. For example, shorting the powerline wiring causes high signal attenuation at downstream client network devices as compared to the upstream client network devices. The client network device may short the powerline wiring by not transmitting a test message when configured in a transmit mode. The client network device may load the powerline wiring by transmitting zeros (e.g., a test message with zeroes in the message fields). After shorting or loading the powerline wiring, the client network device may broadcast test messages in the communication network. The master network device may determine channel characteristics associated with the client network device based, at least in part, on receiving test messages that are broadcast by the client network device, while another client network device shorts or loads the powerline wiring. The master network device may also receive channel characteristics from other client network devices that received the test messages. The master network device may estimate the relative location of the client network device based, at least in part, on the channel characteristics that are determined by the master network device and the channel characteristics that are received from one or more other client network devices. In other embodiments, the master network device may use time-domain channel characteristics and/or frequency-domain channel characteristics to determine the location of the client network device in the communication network.

In one embodiment, the vehicle powerline wiring harness can be designed to allow the master network device to estimate the location of the client network device without introducing additional components on the powerline wiring. The vehicle powerline wiring harness can be designed so that the channel characteristics between the master network device and each client network device are unique. For example, the network devices can be placed at known locations on a powerline wire (e.g., a circuit with multiple network devices connected to a particular fuse), or the powerline wiring can be designed asymmetrically between the left side and the right side of the vehicle.

In another embodiment, the vehicle powerline wiring harness can be designed to allow the master network device to estimate the location of the client network device by introducing additional components on the powerline wiring. One or more passive components (e.g., resistors, indictors, and/or capacitors) may be introduced at various locations along the powerline wiring harness (e.g., during manufacturing) so that the channel characteristics are unique at various locations on the powerline wiring. For example, an inductor and a capacitor can be added in series with a client network device to short the client network device if needed. The passive components may or may not be introduced at the interface between the powerline wiring harness and every network device connected to the powerline wiring harness.

Additionally, to determine the location of the client network device from the channel characteristics, the master network device can take into account the topology of the communication network. The topology of the communication network may be based, at least in part, on an initial learning/training process that is executed on an initial test vehicle during the design and/or manufacturing process. The topology of the communication network may account for variations in manufacturing and/or vehicle configuration between the initial test vehicle and the vehicles that are manufactured.

In some embodiments, the master network device may receive an indication of the location of the client network device in the message received from the client network device. The client network device may determine the channel characteristics between it and the master network device. The client network device may use any of the techniques described above to determine the channel characteristics and its own location. For example, the client network device may determine the channel characteristics based, at least in part, on at least one component introduced on the vehicle powerline wiring harness. As another example, the client network device may transmit test messages and receive channel characteristics from other network devices that received the test messages. The client network device may identify its location in the communication network based on the channel characteristics. In other embodiments, the client network device may be preconfigured with location information that indicates its location in the communication network. For example, the client network device can be preconfigured with the location information during the manufacturing process or by the dealership. The client network device may send the message to report its location to the master network device. After determining the location of the client network device, the flow continues at block 306.

At block 306, the master network device determines registration information for the client network device based, at least in part, on the estimated location of the client network device within the communication network. The registration information may include a TEI a slot allocation schedule, a wake/sleep schedule, an indication of whether the client network device is a relay device, one or more encryption keys, etc. The master network device may provide the client network device with a TEI that is unique on the communication network and that can be used to identify the client network device after successful registration. The TEI may be an 8-bit device identifier or may include any suitable number of bits. The master network device may assign the TEI to the client network device based, at least in part, on device information and/or location. The device information can refer to apart number, a serial number, other suitable device identifier, and/or other information specific to the client network device. For example, for convenience in network configuration and network diagnostics, the left front window control of a vehicle may be assigned the TEI 0x20, the right front window control of the vehicle may be assigned the TEI 0x21, and so on. As another example, if two or more client network devices have the same device information, each of these client network devices may be assigned a TEI based, at least in part; on the location of the client network device. Additionally, one or more TEIs may be reserved as “special TEIs” and may not be assigned to any registered client network devices. For example, the TEI 0x00 may represent client network devices that have not been registered by the master network device; the TEI 0x01 may be assigned to the master network device; the TEI 0xFF may represent a broadcast TEI for broadcast communications; and so on.

The master network device may indicate in the registration information whether the client network device is designated as a relay device and other related information such as the type of messages the client network device is configured to relay and which communication slots should be used for relaying the messages. The master network device may designate any client network device as a relay device irrespective of the actual function performed by the client network device. For example, LED modules, door lock switches, etc. may be designated as relay devices. Furthermore, whether to designate the client network device as a relay device may be predetermined (e.g., when the vehicle is designed) and/or determined by the master network device based, at least in part, on the topology of the communication network. The master network device may select multiple client network devices to relay the same messages during the same communication slots.

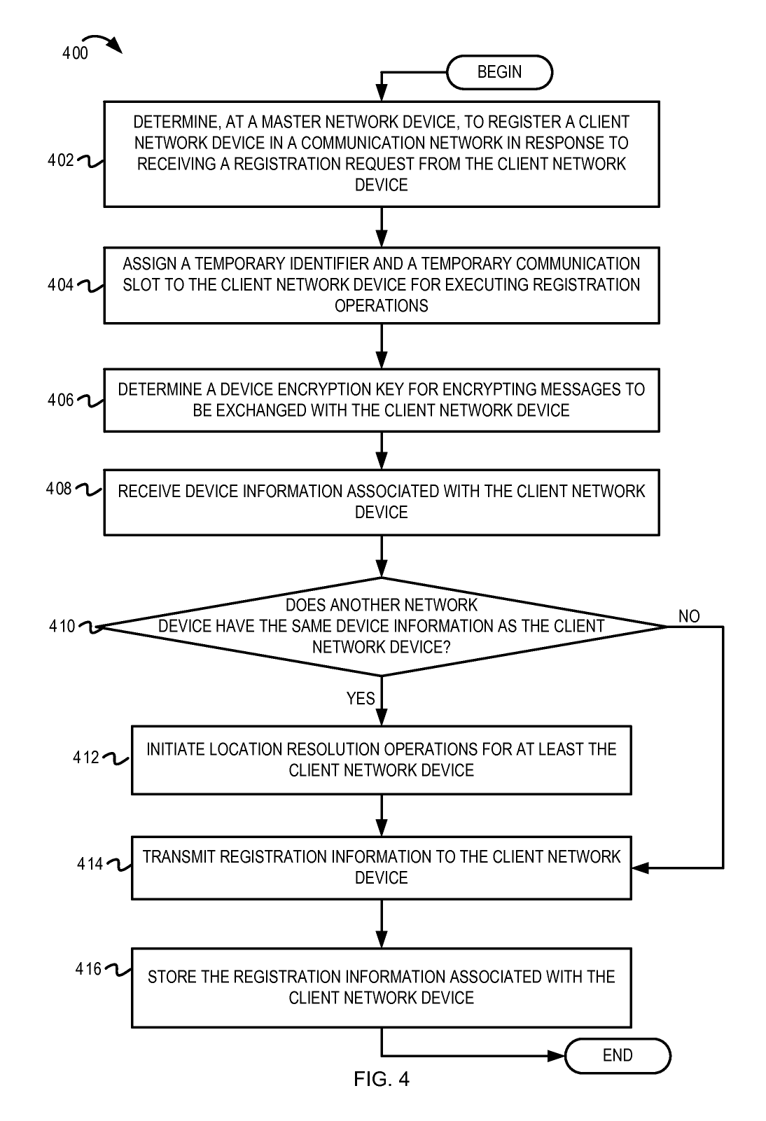

The master network device may provide one or more group encryption keys (GEKs) that can be used to encrypt and decrypt messages transmitted to or received from other network devices that are in communication with the client network device. When the client network device is designated as a relay device, the GEKs that can be used for decrypting messages to be relayed may be provided to the client network device. The master network device may also indicate which GEKs should be used to encrypt messages that are transmitted by the client network device. Registration information may also include a slot allocation schedule indicating communication slots allocated to the client network device for different types of communications, a wake/sleep schedule and/or device location information for the client network device, and a device encryption key (DEK) associated with the client network device. The DEK (further described in FIG. 4) may be used for unicast communication with the client network device. The TEI the DEK, the GEKs, the slot allocation schedule, the wake/sleep schedule, the location information, and an indication of whether the registered client network device is designated as a relay device may collectively or individually be referred to as registration information. The master network device may transmit the registration information to the client network device using a DEK encrypted message. From block 306, the flow ends.

FIG. 4 is a flow diagram 400 illustrating example operations for a master network device to register a client network device in a communication network. The flow 400 begins at block 402.

At block 402, a master network device determines to register a client network device in a communication network in response to receiving a registration request from the client network device. The registration request may include a first temporary identifier (TID) of the client network device. The TID may be randomly selected by the client network device, predetermined, or selected based on certain criteria. Alternatively, the master network device may initiate registration operations to register the client network device in response to a user input, during manufacturing, or in response to other criteria. It is noted that in other embodiments, another suitable network device, such as a previously registered client device may be configured to register the client network device in the communication network.

A client network device may undergo either static registration or dynamic registration to join the communication network and transmit messages in the communication network. Static registration may be used for client network devices that are installed as part of the vehicle. For example, built-in processing and control modules such as lighting control modules, ignition control module, door/window activation modules, etc. may be “statically” registered. Because these client network devices are part of the vehicle, registration information used by these client network devices to operate in the communication network (e.g., the slot allocation schedule, device identifiers, location, etc.) may also be static. The static registration information may be stored in non-volatile memory and the client network devices may re-use the registration information without having to re-register with the master network device. The communication network can become operational faster by eliminating or decreasing the need to re-register. For example, a lighting control module may re-use previously determined registration information each time the vehicle is started or the lighting control module is powered up.

Dynamic registration may be used for client network devices that are peripheral to the vehicle, for example, network devices that gain access to the communication network (e.g., automotive bus) by plugging into a 12-Volt convenience outlet, a diagnostic access port connector, a universal serial bus (USB) port, etc. For dynamic registration, the registration information may remain valid as long as the client network device and the master network device remain powered-on and/or the client network device remains attached to the communication network Dynamic registration may be done each time a client network device is connected to the communication network (e.g., each time a client network device is plugged into the convenience outlet of a vehicle). For dynamic registration, the registration information used in a previous communication session may not be valid for use in a current or future communication session. The flow continues at block 404.

At block 404, the master network device assigns a second temporary identifier and at least one temporary communication slot to the client network device for executing registration operations. After receiving the registration request, the master network device may assign (or allocate) the second temporary identifier and the temporary communication slot to the client network device. In some embodiments, the second temporary identifier is a temporary TEI. The temporary communication slots may be assigned to the client network device for exchanging registration messages during the registration operations. In some embodiments, the temporary communication slots are contention-free communication slots during which other registered or non-registered client network devices may not transmit messages. In other embodiments, the temporary communication slots are contention-based communication slots and the client network device may contend with other non-registered client network devices to gain control of the temporary communication slots. The client network device may transmit subsequent registration messages after gaining control of the contention-based communication slots. The second temporary identifier and an indication of the temporary communication slots may be provided to the client network device as part of a registration response. The temporary communication slots may be included as part of a temporary communication schedule that is provided to the client network device during the registration operations. The registration response may include the first temporary identifier received from the client network device to indicate that the registration response is intended for the client network device. The master network device may use the second temporary identifier to exchange subsequent registration messages with the client network device in the temporary communication slots. The flow continues at block 406.

At block 406, the master network device determines a device encryption key for encrypting messages to be exchanged with the client network device. In one embodiment, the master network device and the client network device perform a Diffie-Hellman key exchange to generate a common secret key referred to as the device encryption key (DEK). Alternatively, the master network device and the client network device may execute other suitable key exchange techniques to generate the DEK. The client network device may initiate the key exchange with the master network device. The master network device and the client network device may use the DEK to encrypt subsequent messages (e.g., registration messages, data messages, etc.) intended for the client network device.

In some embodiments, the master network device determines PHY channel characteristics associated with the client network device based on registration messages, data messages including predetermined data, and/or other suitable messages received from the client network device. The master network device may determine whether these PHY channel characteristics are consistent with those of an expected registering client network device and may terminate the registration if the PHY channel characteristics do not match. The flow continues at block 408.

At block 408, the master network device receives device information associated with the client network device. The device information associated with the client network device can refer to a part number, a serial number, another suitable identifier, or other information specific to the client network device. The client network device may also include the second temporary identifier (provided to the client network device at block 404) to indicate that the client network device transmitted the device information. The device information may be received during a communication slot indicated in the temporary communication slots (indicated to the client network device at block 404). For example, the device information may include a part number of the client network device. The master network device may use the part number to determine the function of the client network device which can allow the master network device to allocate a suitable number of communication slots and determine other registration information (e.g., TEI) for the client network device. The flow continues at block 410.

At block 410, the master network device determines whether another network device has the same device information as the client network device. For example, the master network device may determine whether another network device in the communication network 100 has the same part number as the client network device. If another network device has the same device information as the client network device, the flow continues at block 412. Otherwise, the flow continues at block 414.

At block 412, if another network device has the same device information as the client network device, the master network device initiates location resolution operations. For example, a vehicle may include multiple lighting modules, each of which is associated with the same part number. The master network device may use location resolution operations to determine the location of each of the lighting modules on the vehicle's automotive bus for subsequent communication and control of each lighting module. The master network device may employ various techniques to determine the relative location of the client network device in the communication network. The master network device may then determine the registration information associated with the client network device based, at least in part, on the location of the client network device.

In some embodiments, the master network device transmits a control message to cause each of the client network devices with the same part number to transmit test messages in the communication network. The master network device and other receiving client network devices may receive the test messages and estimate channel characteristics based on the test messages. The master network device may estimate the location of the client network device based, at least in part, on the channel characteristics determined by the master network device and the channel characteristics reported by other client network devices, as described above with reference to FIG. 3.

In some embodiments, the master network device transmits a control message to cause one or more client network devices to selectively “short” or “load” the powerline wiring prior to the client network device transmitting the test messages, as described above with reference to FIG. 3. To determine the location of the client network device from the channel characteristics, the master network device can also take into account the topology of the communication network. Referring to the above example where multiple lighting modules with the same part number were detected, the master network device may determine that a first lighting module is located in the driver door panel and that a second lighting module is located in the passenger door panel based on the channel characteristics. Based on the estimated location of each of the lighting modules, the master network device may assign a first device identifier to the first lighting module and a second device identifier to the second lighting module.

In some embodiments, the vehicle powerline wiring harness is designed to facilitate device location resolution without introducing additional components on the powerline wiring, as described above in FIG. 3. The vehicle powerline wiring harness can be designed so that the channel characteristics between the master network device and each client network device are unique. In another embodiment, the vehicle powerline wiring harness is designed to facilitate device location resolution by introducing additional components (e.g., passive components) on the powerline wiring, as described above in FIG. 3.

In some embodiments, the master network device selectively powers ON/OFF branch circuits in the communication network to help determine the location of the client network device. The master network device may not provide power to one portion of the communication network and may transmit a test message in the communication network. The client network devices that are located in the non-powered portion of the communication network may not respond to the test message. This can enable the master network device to determine the approximate location of the client network devices that did not respond. In some implementations, selective powering of branch circuits can be performed automatically using relays, or manually by installing or removing fuses, turning on or off switches, or by plugging/unplugging cables. Estimating the location of the client network devices by selectively powering portions of the communication network can be facilitated during vehicle manufacture.

Optionally, the master network device may present a notification to a user to indicate whether the client network device should be registered in the communication network. If the user declines, the master network device may terminate the registration operations, revoke the second temporary identifier and the temporary communication slots, and discard the registration information (e.g., the device encryption key). After determining the location of the client network device in the communication network, the flow continues at block 414.

At block 414, the master network device transmits registration information associated with the client network device to the client network device. The master network device can determine the registration information associated with the client network device based, at least in part, on the device information and/or the location of the client network device. The master network device can then provide the registration information to the client network device as similarly described above with reference to FIG. 3. The master network device may use the second temporary identifier assigned to the client network device at block 404 to indicate that the registration information is intended for the client network device. The master network device may also transmit the registration information in one or more temporary communication slots indicated in the temporary communication schedule provided to the client network device at block 404. The flow continues at block 416.

At block 416, the master network device stores the registration information associated with the client network device. The registration information may be stored in an appropriate data structure depending on whether the client network device is statically or dynamically registered. When a client network device is statically registered, some or all of the registration information (e.g., the DEK, TEI, the slot allocation schedule, device location (optionally), etc.) may be stored in non-volatile memory for use across multiple power on/off cycles. At power-up, the master network device may transmit management messages to provide additional information (e.g., beacon period identifier, etc.) to allow statically registered client network devices to rapidly start operating on the communication network. The master network device may communicate registration information updates in management messages or beacon messages during start-up, periodically, on demand, or when new information is available. When a client network device is dynamically registered, the registration information may remain valid as long as the master network device and the client network device remain powered-on and/or the client network device remains connected to the communication network. The master network device may store the registration information associated with the dynamically registered client network device in a volatile data structure. After storing the registration information in the appropriate data structure, the master network device may then discard (or deallocate) the second temporary identifier and temporary communication slots that were assigned to the client network device at the beginning of the registration operations. From block 416, the flow ends.

In some embodiments, the master network device requests user confirmation prior to transmitting the registration information to the client network device. For example, the master network device can present a notification requesting the user to confirm whether the client network device should be registered in the communication network. As another example, the client network device may perform an operation (e.g., switch ON/OFF a light/LED, operate a door lock, open/close a window, power ON the air-conditioning module, etc.) to help the user identify which client network device is being registered. If the user declines or indicates that the client network device should not be registered, the master network device can terminate the registration operations, revoke the second temporary identifier and the temporary communication slots, and discard the registration information.

In some embodiments, a dynamically registered client network device periodically indicates its presence in the communication network to the master network device. The master network device may use a message timeout to determine whether the dynamically registered client network device has left the communication network. If the dynamically registered client network device does not have messages to transmit, the dynamically registered client network device may transmit an empty (“dummy”) message to maintain its dynamic registration. If the master network device does not receive a message from the dynamically registered client network device for a threshold time, the master network device can determine that the dynamically registered client network device is no longer part of the communication network. The master network device can discard any registration information associated with the dynamically registered client network device.

In some embodiments, the master network device reserves a set of communication slots to assign to the dynamically registered client network devices. After dynamically registering a client network device in the communication network, the master network device can assign one or more of the reserved communication slots to the dynamically registered client network device. The master network device can transmit a management message (e.g., a schedule partial update announcement message) to notify all the client network devices in the communication network regarding the communication slots allocated to the dynamically registered client network device.

In some embodiments, the master network device may receive multiple registration requests from multiple client network devices attempting to join the communication network. In some embodiments, the master network device processes each registration request sequentially—in the order in which they were received. For example, the master network device may receive a first registration request from a first client network device and a second registration request from a second client network device. The master network device may process the first registration request and register the first client network device in the communication network. After registering the first client network device, the master network device may process the second registration request and register the second client network device in the communication network. In other embodiments, the master network device processes multiple registration requests in parallel (“fast registration”). Referring to the above example, where the master network device receives a first registration request and a second registration request, the master network device may simultaneously process both registration requests to register both the first and the second client network devices.

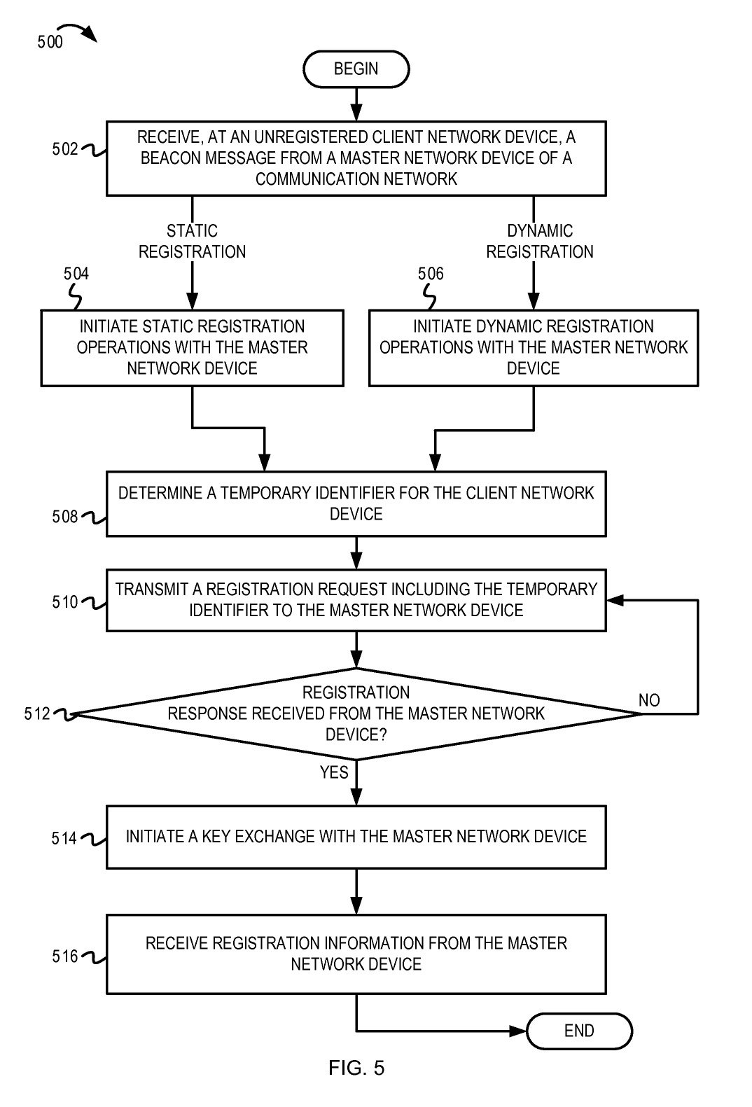

FIG. 5 is a flow diagram 500 illustrating example operations for a client network device to register with a master network device of a communication network. The flow begins at block 502.

At block 502, an unregistered client network device receives a beacon message from a master network device of a communication network. After power-on, the unregistered client network device may parse beacon messages received from the master network device to determine when to initiate registration operations with the master network device. As describe above, the client network device may execute static registration operations if the client network device is installed as a part of a vehicle (e.g., a built-in lighting module). Alternatively, the client network device may execute dynamic registration operations if the client network device is not an installed part of the vehicle (e.g., a plug-and-play module, a diagnostic module, etc.). The client network device may initiate registration operations in different communication slots depending on whether the client network device statically or dynamically registers with the master network device, as will be further described below. If the client network device is configured to initiate static registration operations, the flow continues at block 504. If the client network device is configured to initiate dynamic registration operations, the flow continues at block 506.

At block 504, the client network device initiates static registration operations with the master network device. In some embodiments, the client network device transmits a registration request to the master network device after receiving a beacon message indicating that a static registration schedule will be used. In some embodiments, the static registration operations are initiated in response to receiving a user input or are performed during the manufacturing process. For example, the static registration operations may be triggered by a specific sequence of vehicle switch input manipulations, such as turning the ignition key to the accessory position while pressing another button. In response to detecting the user input, the master network device may transmit an indication that it is accepting static registration requests. The flow continues at block 508.

At block 506, the client network device initiates dynamic registration operations with the master network device. In some embodiments, the client network device transmits a registration request to the master network device after receiving a beacon message. The beacon message may indicate the availability of contention-based communication slots that are allocated for transmitting a registration request. The client network device may also determine which communication slots of the beacon period are contention-based communication slots in the beacon period based, at least in part, on a contention-based slot identifier field in the beacon message. The master network device may periodically allocate contention-based communication slots and may periodically advertise the availability of the contention-based communication slots in the beacon message. In some embodiments, the master network device executes the dynamic registration operations in response to detecting user input. The user input for triggering the dynamic registration operations may be different from the user input fir triggering the static registration operations. In response to detecting the trigger, the master network device may allocate and transmit an indication of the allocated contention-based communication slots in a beacon message. The flow continues at block 508.

At block 508, the client network device determines a first temporary identifier for the client network device. The unregistered client network device that is executing registration operations with the master network device may select a first temporary identifier (TID). The first temporary identifier may be randomly selected, predetermined, or selected based on certain criteria. The first temporary identifier may uniquely identify the client network device during the initial phase of the registration operations. The flow continues at block 510.

At block 510, the client network device transmits a registration request including the first temporary identifier to the master network device. The client network device can periodically transmit the registration request including the first temporary identifier to the master network device. The client network device may transmit the registration request in a contention-based communication slot. As will be discussed in FIGS. 9 and 10, the client network device may contend for control of the contention-based communication slot based, at least in part, on a priority resolution indicator. The priority resolution indicator may be randomly selected, predetermined, assigned by the master network device, or selected based on certain criteria. The client network device may transmit the registration request after gaining control of the contention-based communication slot. In some embodiments, the client network device transmits one registration request per beacon period. It is noted however that in other embodiments the client network device may transmit any suitable number of registration requests per beacon period. The flow continues at block 512.

At block 512, the client network device determines whether a registration response was received from the master network device. The registration response may be broadcast in the communication network (e.g., by including a broadcast TEI) and may include the first temporary identifier associated with the client network device. The registration response may also include a second temporary identifier (e.g., a temporary TEI) assigned by the master network device to identify the client network device for the remainder of the registration operations. The client network device may use the second temporary identifier instead of the first temporary identifier for the remainder of the registration operations. The registration response may also include a temporary communication schedule that indicates communication slots that may be used by the client network device to communicate with the master network device for the remainder of the registration operations. In some embodiments, contention-free communication slots are allocated for exchanging messages for the remainder of the registration operations. In other embodiments, contention-based communication slots are allocated for exchanging messages for the remainder of the registration operations. If the registration response was received, the flow continues at block 514. Otherwise, the flow loops back to block 510, where the client network device continues to transmit the registration request until it receives a registration response from the master network device.

At block 514, the client network device initiates a key exchange with the master network device in response to receiving the registration response. The key exchange may be a Diffie-Hellman key exchange or another suitable key exchange technique. The client network device can initiate the key exchange by transmitting a key exchange request to the master network device. The client network device may receive a key exchange response from the master network device. The client network device may derive a device encryption key (DEK) based, at least in part, on the key exchange. Subsequent messages exchanged between the master network device and the client network device may be encrypted using the DEK. The flow continues at block 516.

At block 516, the client network device receives registration information from the master network device. The client network device may receive the registration information (described above) in a management message that is encrypted using the device encryption key. The client network device may store the registration information in non-volatile memory if the client network device was statically registered. Thus, the client network device and the master network device may retain some or all of the registration information associated with the client network device when power is removed. At power-up, the client network device can use the stored registration information to operate on the communication network, without having to re-register with the master network device. The client network device may store the registration information in volatile memory if the client network device was dynamically registered. The registered client network device can transmit subsequent messages in the communication network (e.g., the automotive bus). The client network device may also discard the second temporary identifier and the temporary communication schedule and use the TEI and the communication schedule provided in the registration information for subsequent communication. From block 516, the flow ends.

In some embodiments, a first unregistered client network device detects a second unregistered client network device with the same temporary identifier as the first unregistered client network device. If the first unregistered client network device has not transmitted the registration request to the master network device, the first unregistered client network device may select a new temporary identifier to avoid conflicts with the second unregistered client network device. In some embodiments, a first registered client network device detects a second registered client network device that has the same TEI as the first registered client network device. The first registered client network device may transmit a conflict report to the master network device indicating that two or more client network devices have the same TEI. The master network device may display an error notification, and may also attempt to re-register the first and the second client network devices.

Each network device (e.g., the master network device and the client network devices) can be configured to support one or more formats of the PLC message (e.g., a HomePlug physical layer protocol data unit (PPDU)). FIG. 64 depicts an example format of a PPDU 600 for transmission on a PLC automotive bus (“PLC-AB PPDU”). The PPDU 600 includes a preamble field or a short delimiter field 602, a frame control field 604, and a medium access control (MAC) protocol data unit (MPDU) 606. The MPDU 606 may be generated by the MAC layer and may include data for transmission to a destination network device. The physical layer may add the preamble field (or short delimiter field) 602 and the frame control field 604 to the MPDU 606 received from the MAC layer to form the PPDU 600. FIG. 6A also depicts the inter-frame spacing (IFS) 608 that may be maintained after transmission of the PPDU 600. The inter-frame spacing 608 can refer to a minimum buffer time interval that is maintained after one message is transmitted and before the next message is transmitted. Maintaining the inter-frame spacing 608 can minimize the possibility of collisions between two consecutive message transmissions. The inter-frame spacing 608 is depicted using dashed lines because the inter-frame spacing 608 is not part of the PPDU 600. However, the sum of the PPDU 600 and the inter-frame spacing 608 may be referred to as “total transmission time” 610. The network devices may transmit varying amounts of PLC-AB traffic by supporting PPDUs and MPDUs with different field lengths.

For example, the network device may support a 16-byte PLC-AB PPDU (e.g., HomePlug Green PHY Automotive Bus (HPGP-AB) PPDU). The 16-byte PLC-AB MAI may include a HomePlug AV preamble field and a frame control field that includes a single Orthogonal Frequency-Division Multiplexing (OFDM) symbol. The 16-byte PLC-AB PPDU may have a 110.48 us duration and may be associated with a 14.52 us inter-frame spacing (i.e., a total transmission time of 125 μs). The 16-byte PLC-AB PPDU may support transmission of a 16 byte PLC-AB MPDU. As another example, the network device may support a 32-byte PLC-AB PPDU. The 32-byte PLC-AB PPDU may include a HomePlug AV preamble field and a HomePlug AV2 32-bit frame control field that includes a single OFDM symbol. The 32-byte PLC-AB PPDU may have a 110.48 us duration and may be associated with a 14.52 us inter-frame spacing (i.e., a total transmission time of 125 μs). The 32-byte PLC-AB PPDU may support transmission of a 32-byte PLC-AB MPDU. As another example, the network device may support a 16-byte PLC-AB short delimiter PPDU (SD-PPDU). The 16-byte PLC-AB SD-PPDU may include a HomePlug AV2 short delimiter and a 128-bit frame control field. The 16-byte PLC-AB SD-PPDU may have a 55.48 us duration and may be associated with a 7.02 us inter-frame spacing (i.e., a total transmission time of 62.5 μs). The 16-byte PLC-AB SD-PPDU may support transmission of a 16-byte PLC-AB MPDU. As another example, the network device may support a 32-byte PLC-AB SD-PPDU. The 32-byte PLC-AB SD-PPDU may include a HomePlug AV2 short delimiter and a 256-bit frame control field. The 32-byte PLC-AB SD-PPDU may have a 55.48 us duration and may be associated with a 7.02 us inter-frame spacing (i.e., a total transmission time of 62.5 μs). The 32-byte PLC-AB SD-PPDU may support transmission of a 32-byte PLC-AB MPDU. In some embodiments, a network device communicating on the automotive bus supports one or more default PPDU formats. The network device may support the 16-byte PLC-AB PPDU and the 32-byte PLC-AB PPDU by default. The network device may optionally support the 16-byte PLC-AB SD-PPDU and the 32-byte PLC-AB SD-PPDU. It is noted that the network devices communicating on the automotive bus may support any suitable number and type of PPDU formats with a suitable number of fields and bits/bytes per field.

In some embodiments, a network device communicating on the automotive bus supports two MPDU formats—a message 11) MPDU format and a TEI MPDU format. FIG. 6B depicts an example of a message ID MPDU format 650. The message ID MPDU format 650 may be used to transmit data. The message ID MPDU format 650 may include a sequence field 652, a message ID field 654, a payload field 656, and a cyclic redundancy check (CRC) field 658. For example, the message ID MPDU format 650 may include a 2-bit sequence field 652, a 14-bit message ID field 654, and a 32-bit CRC field 658. The message ID MPDU format 650 may also include a 10-byte or a 26-byte payload field 656 depending on whether a 1.6-byte MPDU or a 32-byte MPDU is being transmitted. Alternatively, the message ID MPDU format 650 may include any suitable number of fields, and each field may include any suitable number of bits. The sequence field 652 may be incremented for every new message that is transmitted by the network device. The message ID field 654 may indicate the function of the message that is being transmitted. For example, the message ID field 654 may indicate whether a lighting control message, an ignition start/stop message, or another suitable type of message is being transmitted. A receiving network device may use the message ID field 654 to determine how to process a message that was generated using the message ID MPDU format. The CRC field 658 may include a non-inverted CRC value, where “non-inverted” indicates that the message ID MPDU format is being used. The payload field 656 may include data that may be used for controlling a vehicle, for example, turning the lights on and off, checking the status of sensors, etc. The message generated using the message ID MPDU format 650 may be transmitted by a master network device or a client network device. For example, the master network device and the client network device may each be network devices (or communication components) within a vehicle. The message generated using the message ID MPDU format 650 may be a LIN bus message or a CAN bus message that is transmitted between communication components of the vehicle via a PLC network. For example, the master network device may be the central computer within the vehicle; while the client network devices may be the heating and cooling system, charging and battery modules, entertainment devices, security system components, etc. within the vehicle.

FIG. 6C depicts an example of a TEI MPDU format 680. The TEI MPDU format may be used to transmit management messages and/or vehicle control messages. The TEI MPDU format 680 includes a control field 682, a destination address field 684, a payload field 690, and a CRC field 692. Optionally, the TEI MPDU format 680 may also include a source address field 686 and a sequence identifier field 688—each depicted using dashed lines. For example, the TEI MPDU format 680 may include an 8-bit control field 682 and an 8-bit destination address field 684. The TEI MPDU format 680 may include an 8-byte or a 26-byte payload field 690 depending on whether a 16-byte MPDU or a 32-byte MPDU is being transmitted. The TEI MPDU format 680 may include an inverted 32-bit CRC field 692. Additionally, the TEI MPDU format 680 may include an 8-bit source address field 686 and/or an 8-bit sequence identifier field 688. Alternatively, the TEI MPDU format 680 may include any suitable number of fields, and each field may include any suitable number of bits. The control field 682 may indicate the type of message that will be transmitted. As will be further described below, the control field 682 may indicate the type of payload that will be transmitted, whether the message is a broadcast message, whether the message is a segmented message, etc. The destination address field 684 may include a unicast or multicast destination address (e.g., destination terminal equipment identifier or DTEI). The CRC field 692 may be inverted to indicate that the message is being transmitted using the TEI MPDU format.

The control field 682 may include a message sub-type field that indicates whether the message includes beacon information, data, or management information (e.g., a slot allocation schedule, encryption key, etc.). When data is being transmitted, the message sub-type field may also indicate whether the message includes the optional source address field 686 and what type of application the data is from (e.g., whether the data is from an Ethernet application or a PLC (native) application), in one embodiment, the message sub-type field may be a 3-bit field. The control field 682 may also include a destination type field that indicates whether the destination address field 684 includes a unicast, broadcast or multicast destination address. For example, if destination type field is a 1-bit field, a value of “1” may indicate that the message is destined for multiple PLC devices and that the destination address represents a broadcast/multicast destination identifier. The control field 682 may also include a segmented message field that indicates whether the message being transmitted is a portion or segment of a larger original message. For example, the segmented message field may be a 2-bit field. A value of “00” may indicate that the message is not a segmented message and does not include a sequence identifier field. A value of “01” may indicate that the message is the first segment of a larger original message. A value of “10” may indicate that the message is an intermediate segment of the larger original message. A value of “11” may indicate that the message is the final segment of the larger original message. For the examples where the message is the first, intermediate, or final segment of an original message, the message generated using the TEI MPDU format 680 may include the sequence identifier field 688 if it is transmitted in a contention-based communication slot.

In some embodiments, the master network device transmits the beacon message using an unencrypted 16-byte PLC-AB PPDU that includes a 16-byte MPDU. The MPDU may be generated using the TEI MPDU format 680 described above. Referring to FIG. 6C, the control field 682 may indicate that the MPDU includes beacon information, is not segmented, and does not include the source address field 686. The destination address field 684 may include a broadcast/multicast destination identifier (e.g., 0xFF). Alternatively, the beacon message may not include the destination address field 684. The payload field 690 may include a 1-byte beacon information field, a 1-byte beacon slot identifier field, a 1-byte beacon period number (BPN) LSByte field, a 1-byte BPN byte n field, and 1-byte contention-based slot identifier field. Additionally, the beacon message may also include an inverted CRC value in the 32-bit CRC field 692. Additional description of each of these fields is further described below.

The beacon information field may include a wake/sleep field, a schedule control field, and a BPN byte number field. The wake/sleep field may indicate whether all the client network devices receiving the beacon message should remain in the active operating state. For example, if the value in the wake/sleep field is “1” this can indicate that all the client network devices should remain in the active operating state during the current and next beacon period and listen for messages during all the communication slots assigned to the master network device. The schedule control field may identify the schedule that the client network devices should use for subsequent operation. For example, a value of “00” may indicate that all transmissions by client network devices should be disabled. A value of “01” may indicate that each client network device should operate according to the slot allocation schedule previously provided by the master network device. A value of “10” may indicate that the client network devices should operate according to a static registration schedule. The BPN byte number field can indicate the byte number (i.e., which byte) that is transmitted in the BPN byte n field.

The master network device can use the BPN byte number field, the BPN LSByte field, and the BPN byte n field to notify the client network devices of the beacon period identifier using a limited number of bits. Knowledge of the beacon period identifier can help the client network devices encrypt/decrypt messages, determine a communication schedule which can vary from one beacon period to another, determine a wake/sleep schedule for power conservation, etc. For example, a contention-based communication slot may be allocated once every four beacon periods, when the two least significant bits representing the beacon period identifier are zero. The BPN LSByte field may include the least significant byte (LSB) of the beacon period identifier. The BPN byte n field may include the portion of the beacon period identifier indicated in the BPN byte number field of the beacon information field. For example, if the beacon period identifier is 16 bytes (i.e., byte 0-byte 15), the BPN LSByte field includes the last byte (e.g., 15) of the beacon period identifier. In this example, the BPN byte number field indicates which byte is being transmitted in the BPN byte n field. Thus, if the BPN byte number field indicates “byte 0,” then the BPN byte n field includes the first byte of the beacon period identifier. The client network device can determine the entire beacon period identifier by listening to multiple beacon messages. For example, if the beacon period identifier is 16 bytes, the client network device listens to 15 beacon messages to determine the entire beacon period identifier.

The beacon slot identifier field may indicate the communication slot in which the beacon message is being transmitted. If the beacon message is transmitted over multiple communication slots (e.g., three adjacent communication slots), the beacon slot identifier field may indicate the first communication slot in which the beacon message will be transmitted. If the number of bits used to represent the communication slot identifier exceeds the number of bits allocated for the beacon slot identifier field, the most significant bits of the communication slot identifier may be included in the beacon slot identifier field. The contention-based slot identifier field can include N most significant bits (e.g., 8 MSBs) of the communication slot identifier of the first communication slot in the set of contiguous contention-based communication slots allocated in the following beacon period. A value of zero (e.g., N=0) may indicate that there are no contention-based communication slots available in the next beacon period. The contention-based communication slots indicated in the beacon message may be used for transmitting registration messages. Network devices may contend for control of these communication slots using a randomly selected priority resolution indicator. In some embodiments, contiguous communication slots are allocated to allow a client network device to contend for control of the communication medium and transmit a 16-byte PLC-AB PPDU or a 32-byte PLC-AB PPDU.

Various medium access techniques may be supported for PLC automotive bus communication (PLC-AB traffic). For example, contention-free access (CFA), collision-free contention access (CPCA), and randomized priority contention access (RPCA) may be supported. The master network device may allocate communication slots to a client network device based, at least in part, on the medium access techniques that will be used to transmit a message on the communication medium. FIGS. 7 and 8 will describe operations for allocating communication slots for contention-free access of the communication medium. FIGS. 9 and 10 will describe operations for allocating communication slots for contention-based access of the communication medium.

FIG. 7 is a flow diagram 700 illustrating example operations of a master network device allocating communication slots for contention-free access of a communication medium. The flow 700 begins at block 702.

At block 702, a master network device determines to assign communication slots to a client network device for contention-free access of a communication medium (“contention-free communication slots” or “CFA communication slots”). The master network device may allocate the CFA communication slots in response to a request from the client network device or after registering the client network device in the communication network. The contention-free communication slots assigned to a single client network device during a beacon period may be referred to as a “CFA allocation.” The CFA allocation may include a message transmission interval followed by an inter-frame spacing. The CFA allocation may include any suitable predetermined or configurable number of contention-free communication slots. In some embodiments, the master network device and the client network device are electronic devices within an automobile (e.g., for intra-vehicular communications. For example, the master network device and the client network device may be electronic devices that implement one or more wired communication protocols (e.g., PLC protocol, MoCA protocol, etc. and/or one or more wireless communication protocols (e.g., a WLAN protocol, etc.). The flow continues at block 704.

At block 704, the master network device determines transmission information associated with the client network device. The transmission information may include one or more classes of traffic (“traffic class”) that will be transmitted by the client network device, the number of messages of each traffic class that will be transmitted by the client network device, the type of messages that will be transmitted by the client network device, and/or the periodicity (if any) of the messages. The type of message may refer to the content of the message, such as whether the message is a heating and cooling system control and/or status message, charging and battery control and/or status message, entertainment device control and/or status message, security system control and/or status message, etc. In one embodiment, traffic exchanged in a contention-free communication slot are classified into three traffic classes—traffic class A, traffic class B, and traffic class C. A message that is classified into traffic class A (“class A message”) may have a 2 ms latency, such that the time difference between generating and transmitting the class A message is less than or equal to 2 ms. The master network device allocates a maximum of ten contention-free communication slots for class A messages per 20 ms beacon period. If each message is repeated twice (e.g., three total transmissions of a particular message), a network device may transmit a class A message every 6 ms with a latency of 10 ms. A message that is classified into traffic class B (“class B message”) may have a 10 ms latency, such that the time difference between generating and transmitting the class B message is less than or equal to 10 ins. The master network device allocates a maximum of two contention-free communication slots for class B messages per 20 ms beacon period. A message that is classified into traffic class C (“class C message”) may have a 20 ms latency, such that the time difference between generating and transmitting the class C message is less than or equal to 20 ms. The master network device allocates a maximum of one contention-free communication slot for class C messages per 20 ms beacon period. The contention-free communication slots allocated for retransmitting the class A, B, and/or C messages may be indicated in the slot allocation schedule. However, in other embodiments, the traffic exchanged in the communication network may be classified into any suitable number of traffic classes. Also, each of the traffic classes may have any suitable period and/or latency parameters. The flow continues at block 706.

At block 706, the master network device allocates contention-free communication slots to the client network device based, at least in part, on the transmission information. FIG. 8 depicts an example slot allocation schedule illustrating assignment of contention-free communication slots. In some implementations, the contention-free communication slots may be allocated based, at least in part, on either the latency parameters or the time cycle (i.e., period) parameters—whichever is shorter. The master network device may divide a beacon period into sub-intervals, and each sub-interval may be further divided into communication slots (also referred to as “communication time slots”). FIG. 8 depicts an example graph of sub-intervals within a beacon period (Y-axis) versus communication slots per sub-interval (X-axis). In the example of FIG. 8, the beacon period is 20 ins and the beacon period is divided into 2 ms sub-intervals (depicted on the Y-axis). Thus, the 20 ms beacon period shown in FIG. 8 comprises ten 2 ms sub-intervals starting with a 0-2 ms sub-interval and ending with an 18 ms-20 ms sub-interval. Additionally, each sub-interval shown in FIG. 8 is divided into 32 communication slots (depicted on the X-axis) such that each communication slot is 62.5 μs. It is noted that in other embodiments, the beacon period, the sub-intervals within the beacon period, and/or the communication slots may have other suitable duration. For a 20 ms beacon period and 2 ms message transmission latency, the master network device may allocate ten communication slots to the client network device per beacon period. For a 20 ms beacon period and 10 ms message transmission latency, the master network device may allocate two communication slots to the client network device per beacon period. For a 20 ms beacon period and 20 ms message transmission latency, the master network device may allocate one communication slot to the client network device per beacon period. The slot allocation schedule of FIG. 8 also depicts the first two communication slots of a beacon period being assigned for beacon message transmission. It is noted that the master network device may assign communication slots that are different from those depicted in FIG. 8 depending on the communication slots previously assigned by the master network device. Furthermore, the master network device may use other types of transmission information to allocate communication slots to the client network device. For example, the master network device may allocate contention-free communication slots to the client network device based, at least in part, on the type of messages transmitted by the client network device. The flow continues at block 708.

At block 708, the master network device transmits an indication of the allocated contention-free communication slots to the client network device. In some embodiments, the indication of the allocated contention-free communication slots is transmitted as part of a slot allocation schedule described above. In other embodiments, the master network device transmits the indication of the allocated contention-free communication slots associated with the client network device in a unicast message to the client network device. From block 708, the flow ends.

It is noted that a client network device may not transmit any messages during a contention-free communication slot that is assigned to another client network device. If two adjacent contention-free communication slots are assigned to the client network device, the client network device may transmit one 16-byte SD-PPDU, one 32-byte SD-PPDU, one 16-byte PPDU, one 32-byte PPDU, two 16-byte SD-PPDU, or two 32-byte SD-PPDUs. However, the number and type of messages that can be transmitted in a contention-free communication slot may be controlled by the master network device and indicated as part of the slot allocation schedule.

FIGS. 7 and 8 describe the master network device allocating contention-free communication slots to a client network device for each class of messages that will be transmitted by the client network device. However, the contention-free communication slots may be assigned for use by a single client network device and for transmitting any suitable traffic classes generated by the client network device. For example, if ten communication slots are assigned to a client network device, the client network device may use the assigned ten communication slots to transmit any type of messages that belong to any traffic class.

The master network device may reserve communication slots in anticipation of future requests from client network devices for contention-free communication slots. The number of communication slots that are reserved may be predefined and configurable. For example, with reference to FIG. 8, the master network device may reserve communication slots 9-11 for each sub-interval of each beacon period in anticipation of future requests from client network devices.

Certain types of messages may be rarely transmitted in the communication network. For example, door lock/unlock messages, ignition start/stop messages, etc. may be rarely transmitted in the communication network. Accordingly, the master network device may designate some communication slots as contention-based communication slots for transmitting these infrequent messages. The network devices 102, 104, and 114 may execute a contention-based technique for gaining control of a contention-based communication slot and for determining which network device should transmit during the contention-based communication slot, as will be further described in FIGS. 9 and 10.

FIG. 9 is a flow diagram 900 illustrating example operations of a client network device for contention-based access of a communication medium. The flow begins at block 902.

At block 902, a client network device identifies a contention-based communication slot that is allocated for contention-based access of the communication medium. The contention-based communication slot may be a communication slot that is allocated for collision-free contention access of the communication medium (“CFCA communication slot”. The client network device may identify the CFCA communication slots based, at least in part, on registration information transmitted by a master network device of the communication network. The communication slots that are assigned (per beacon period) and that are used for collision-free contention access may be referred to as a “CFCA allocation.” The communication slots that are part of a CFCA allocation may be contiguous. Referring to the example of FIG. 8, communication slots 8, 9, and 10, during the 6-8 ms sub-interval of the beacon period are allocated for contention-based communication and are referred to as a CFCA allocation. A CFCA allocation may be assigned to a group of client network devices (“CFCA contention group”) for transmitting messages on the communication medium. A group of client network devices that can “robustly communicate” with each other may be assigned to the same CFCA contention group. The group of client network devices that can robustly communicate with each other may include client network devices that can reliably receive signals from each other with a signal strength that exceeds a signal strength threshold, with an attenuation that does not exceed an attenuation threshold, and without the use of relay devices. Robust communication between the client network devices within the CFCA contention group can indicate that there are no hidden nodes and no marginal links between the client network devices of the CFCA contention group. Robust communication between client network devices within the same CFCA contention group can ensure that these client network devices can detect each other when they contend for a contention-based communication slot. This can minimize the possibility of collisions between messages transmitted by two or more client network devices. A group of client network devices that are configured to transmit the same type(s) of message may also be assigned to the same CFCA contention group. For example, client network devices that transmit a door lock/unlock message may be assigned to the same CFCA contention group. As another example, client network devices that transmit door lock/unlock messages and client network devices that transmit light activation messages may be assigned to the same CFCA contention group.

The contention-based communication slot may be a communication slot that is allocated for randomized priority contention access (“RPCA communication slot”) of the communication medium. For example, the client network device may identify the RPCA communication slot based, at least in part, on registration information transmitted by the master network device or information in a beacon message transmitted by the master network device. The communication slots (per beacon period) that are assigned for randomized priority contention access may be referred to as an “RPCA allocation.” The communication slots that are part of an RPCA allocation may be contiguous. For example, with reference to FIG. 8, communication slots 12, 13, and 14 during the 8-10 ms sub-interval of the beacon period may be allocated for random priority contention access of the communication medium and may be referred to as an RPCA allocation.

RPCA allocation may be assigned to a group of client network devices (“RPCA contention group”). The master network device may assign a different range or group of priority resolution indicators to each of the client network devices in the RPCA contention group for selecting their respective priority resolution indicator. This can allow for differentiation in priority between client network devices. To contend for the RPCA allocation, each client network device may randomly select a priority resolution indicator from the range or group assigned to it. In some implementations, the range/group assigned to a client network device does not overlap with range/group assigned to another network device. In other implementations, the range/group assigned to a client network device may overlap with range/group assigned to another network device. In yet other implementations, a client network device is assigned a fixed set of priority resolution indicators that may or may not be contiguous. In one example, five priority resolution slots (a total of 2⁵=32 different priority resolution indicators) are available. A first client network device may be assigned a range of 0-20; a second client network device may be assigned a range of 15-30; and a third client network device may be assigned (or the master network device may assign itself) a range of 31 to 31 (i.e., a highest priority resolution indicator of 31). In this example, the third client network device (or the master network device) gains control of the RPCA allocation whenever it contends.

In some embodiments, the RPCA allocation per beacon period is statically scheduled and is indicated in the slot allocation schedule. For example, the slot allocation schedule may indicate one or more contention-based communication slots that are allocated for a group of client network devices (e.g., door lock switches). The group of client network devices may contend for control of the allocated contention-based communication slots using a randomly selected priority resolution indicator. In other embodiments, the RPCA allocation is dynamically scheduled. For example, the RPCA allocations in the next beacon period may be indicated in a beacon message of a current beacon period. The RPCA communication slots may be indicated in the contention-based slot identifier field of the beacon message, RPCA allocations indicated by this field may start on an even numbered communication slot. The contention-based slot identifier field can indicate the N most significant bits (e.g., 8 MSBs) of the communication slot identifier associated with the first communication slot in the RPCA allocation in the following beacon period. Referring to the above example, where communication slots 12, 13, and 14 are assigned as an RPCA allocation, the communication slot identifier associated with communication slot 12 in the 8-10 ms sub-interval may be indicated in the beacon message.

A registered client network device that has been assigned a priority resolution indicator by the master network device may use the CFCA communication slots, e.g., to transmit data. A registered or unregistered client network device that has not been assigned a priority resolution indicator or a contention-free communication slot may use the RPCA communication slots, e.g., to transmit management messages (MMEs) or to initiate registration operations. The contention-based communication slot (e.g., the CFCA communication slot and the RPCA communication slot) may include a priority resolution contention interval followed by a message transmission interval and an inter-frame spacing (IFS) as will be further described below. The contention-based communication slot may include multiple communication slots to allow the registered client network device to contend for control of the communication medium and transmit a 16-byte PLC-AB PPDU or a 32-byte PLC-AB PPDU. The flow continues at block 904.

At block 904, the client network device determines a priority resolution indicator. The client network device may use the priority resolution indicator (e.g., a priority resolution number) to contend for control of the contention-based communication slot. For collision-free contention access, the client network devices in a CFCA contention group may each be assigned a priority resolution indicator that is unique within the CFCA contention group. The client network devices in the CFCA contention group may contend with each other to gain control of the communication medium and transmit during the CFCA communication slots.

In some embodiments, the priority resolution indicators are rotated/updated in a predetermined manner (e.g., rotated in a random order or a defined order) so that each client network device in the CFCA contention group has a different (yet unique) priority resolution indicator for each beacon period (or for a predetermined number of beacon periods). This can avoid a single client network device with the highest priority always gaining control of the contention-based communication slot. In one implementation, a subset of bits of the beacon period indicator may be combined with a current priority resolution indicator to generate a new priority resolution indicator. For example, for n priority resolution slots, the client network device may add the n least significant bits of the beacon period identifier to the current priority resolution indicator of the client network device. The client network device may use the n least significant bits of the result as the new priority resolution indicator. As another example, for an n-bit priority resolution indicator, the n-least significant bits of the beacon identifier may be XORed or added modulo N (where N=2ⁿ) to the current priority resolution indicator of a client network device to yield the new priority resolution indicator of the client network device is noted, however, that other suitable techniques may be employed for varying the priority resolution indicators after one or more beacon periods. For example, the bits of the beacon identifier may be reversed (e.g., so that the least significant bits become the most significant bits and vice versa) before combining with the current priority resolution indicator.

For random priority contention access, the client network device is not assigned a priority resolution indicator by the master network device. Therefore, the client network device may randomly generate a priority resolution indicator to contend for control of the RPCA communication slot. The client network device may use a suitable random or pseudo-random number generator to generate the priority resolution indicator. In some implementations, the client network device may randomly select a priority resolution indicator that falls within a range specified by the master network device. The client network device may randomly generate a new priority resolution indicator each time it contends for control of an RPCA communication slot. The flow continues at block 906.

At block 906, the client network device transmits priority resolution symbols (PRS) to contend for control of the contention-based communication slot based, at least in part, on the priority resolution indicator. The contention-based communication slots may be CFCA communication slots or RPCA communication slots depending on whether the client network devices are assigned a priority resolution indicator by the master network device or whether the client network devices randomly select a priority resolution indicator. In some embodiments, client network devices that belong to the same group contend for control of the contention-based communication slots allocated to the group of client network devices. In other embodiments, any client network device contends for control of a contention-based communication slot. As depicted in FIG. 10, a contention-based communication slot 1002 includes a contention interval 1004 and a message transmission interval 1006. The contention interval 1004 may be further divided into PRS signaling slots—one PRS signaling slot for transmitting each priority resolution symbol. For example, the priority resolution indicator may be represented using seven priority resolution symbols (or a 7-bit binary number). In this example, there are 2⁷=128 unique priority resolution indicators that can be assigned by the master network device to different client network devices in the CFCA contention group to contend for the CFCA communication slot. Alternatively, there may be 2⁷=128 unique priority resolution indicators that can be randomly generated by a client network device to contend for the RPCA communication slot. In other embodiments, the priority resolution indicator may be represented using any suitable number of bits. In the example of FIG. 10, the contention interval 1004 is sub-divided into seven PRS signaling slots 1008A-1008G for transmitting priority resolution symbols PRS0-PRS6 respectively.

The contention-based communication slot 11002 and the PRS signaling slots 1008A-1008G may be any suitable duration. Additionally, the contention-based communication slot 1002 may include any suitable number of PRS signaling slots. The number of PRS signaling slots may vary depending on the number of client network devices that can contend for control of the contention-based communication slot. A larger number of PRS signaling slots can result in fewer collisions between the contending network devices. The client network device may contend for control of the contention-based communication slot during the contention interval 1004 when it has a message queued for transmission. The client network device may transmit a predefined message in the PRS signaling slot when the corresponding priority resolution symbol has a value of 1, for example. The client network device may not transmit the predefined message in the PRS signaling slot when the corresponding priority resolution symbol has a value of 0. The client network device may listen for signals transmitted by other client network devices when the client network device does not transmit the predefined message in the PRS signaling slot. For example, if the priority resolution number of the client network device is represented by PRS0-PRS6=0111001, the client network device transmits the predefined message during PRS signaling slots 1008B, 1008C, 1008D, and 1008G (e.g., when PRS1, PRS2, PRS3, and PRS6 have a value=1). The client network device listens for transmissions from other client network devices during PRS signaling slots 1008A, 1008E, and 1008F (e.g., when PRS0, PRS4, and PRS5 have a value=0). The flow continues at block 908.

At block 908, the client network device determines whether priority resolution symbols were detected from another network device. The client network device may determine whether another network device should gain control of the contention-based communication slot based, at least in part, on whether priority resolution symbols were detected from another network device. Referring to the above example, the client network device may determine whether the predefined message was detected during PRS signaling slots 1008A, 1008E, and 1008F (e.g., when PRS0, PRS4, and PRS5 have a value=0). If the client network device detects a PRS signal in a slot in which it is listening, the client network device loses priority resolution contention and does not transmit PRS signals in subsequent PRS slots. If the client network device detects a PRS signal in PRS signaling slot 1008A, the client network device will lose contention and will not transmit during subsequent PRS signaling slots 1008B, 1008C, 1008D, and 1008G (even though PRS1, PRS2, PRS3, and PRS6 have a value=1). If the priority resolution symbols were not detected from another network device, the flow continues at block 910. Otherwise, if priority resolution symbols were detected from another network device, the flow continues at block 912.

At block 910, when priority resolution symbols are not detected from another network device, the client network device gains control of the contention-based communication slot. The client network device may gain control of the contention-based communication slot if priority resolution symbols were not detected from another network device during the contention interval 1004. The client network device may gain control of the contention-based communication slot if the client network device has the highest priority resolution indicator among all the contending network devices. The client network device may transmit a message during the message transmission interval 1006 after the contention interval 1004 elapses. The client network device may transmit multiple messages during the message transmission interval 1006 depending on the duration of the message transmission interval 1006 and the duration of the messages to be transmitted. From block 910, the flow ends.

At block 912, when a priority resolution symbol is detected from another network device, the client network device determines not to transmit the message during the contention-based communication slot. The client network device may not have control of the contention-based communication slot if priority resolution symbols were detected from another network device during the contention interval 1004. The client network device may also determine that it has a lower priority resolution indicator as compared to another contending network device. The client network device may defer transmitting the message and may relinquish control of the contention-based communication slot to the other network device with the higher priority resolution indicator. The client network device may contend for control of another contention-based communication slot to transmit the message. From block 912, the flow ends.

In some embodiments, the master network device does not specifically allocate RPCA communication slots. Instead, the client network devices that are not assigned a priority resolution indicator or a contention-free communication slot may contend for control of the CFCA communication slots. The master network device may restrict the range of priority resolution indicators that are used for RPCA and CFCA. The master network device may assign priority resolution indicators within a first range to the first set of network devices that implement CFCA. The master network device may notify the second set of network devices that implement RPCA to randomly select their respective priority resolution indicator from a second range that does not overlap with the first range. This can eliminate or reduce overlap in priority resolution indicators used by the first set and the second set of network devices. The first set and the second set of network devices may then use their respective priority resolution indicator to contend for control of the CFCA communication slot.

The master network device can control the types of messages that can be transmitted in contention-free communication slots and the contention-based communication slots. The master network device may use the slot allocation schedule to indicate the types of messages that can be transmitted in each type of communication slot. The master network device may restrict the messages that can be transmitted in the communication slots based, at least in part, on message format (e.g., message ID or TEI), message ID (for message ID MPDU format), destination address, type of message (e.g., whether a registration message, an acknowledgment message, etc.), and/or other suitable factors.

In some embodiments, data that is too long to be transmitted in a single payload field is segmented to form “segmented MPDUs” or “segmented messages.” For example, an original message that is generated using the TEI MPDU format (described in FIG. 6C) may be segmented to form two or more segmented messages. Segmentation and re-assembly of an original message that is generated using the message ID MPDU format (described in FIG. 69) may be supported at the application layer.

FIG. 11 is a flow diagram 1100 illustrating example operations for transmitting segmented messages. The flow 1100 begins at block 1102.

At block 1102, a first network device determines to generate a plurality of segmented messages for transmission. The first network device may be a client network device in communication with a master network device or another client network device, or the first network device may be the master network device in communication with a client network device. The first network device may generate two or more segmented messages in response to determining that an original message is too long to be transmitted using a single MPDU (e.g., the MPDU format shown in FIG. 6C). For example, the first network device generates the segmented messages if the length (e.g., number of bytes) of the original message exceeds a threshold message length. The threshold message length (e.g., threshold number of bytes) may be determined based, at least in part, on the maximum number of bytes that can be transmitted in the payload field 690 of the MPDU format shown in FIG. 6C. In some embodiments, a segmented message length field is pre-pended to the message portion of the segmented message, and a CRC field is appended to the end of the message portion. For example, the segmented message length field is 16-bits long and the CRC field is 32-bits long. Alternatively, a segmented message may include any suitable number/type of fields with any suitable length and number of bits. The CRC field may be calculated over the segmented message length field and the message portion. In addition, the segmented message may include an optional pad field after the CRC field so that the length of the segmented message is a supported MPDU length. The flow continues at block 1104.

At block 1104, the first network device determines whether the segmented messages will be transmitted in a contention-free communication slot or a contention-based communication slot. If the segmented messages will be transmitted in a contention-based communication slot, the flow continues at block 1106. Utile segmented messages will be transmitted in a contention-free communication slot, the flow continues at block 1108.

At block 1106, if the first network device determines to transmit the segmented messages in a contention-based communication slot, the first network device includes a sequence identifier for each segmented message. The flow continues at block 1110.

At block. 1108, if the first network device determines to transmit the segmented messages in a contention-free communication slot, the first network device determines not to include the sequence identifier in any of the segmented messages. Instead of including a sequence identifier for the segmented messages, the first network device may transmit each segmented message in a contention-free communication slot that is assigned to the first network device, as will be further described below. Although the segmented messages may not include sequence identifiers, each segmented message may include an indication of whether the segmented message is the first segment, the final segment, or an intermediate segment of the original message. The flow continues at block 1110.

At block 1110, a segmented message is transmitted in the communication slot. As described above, the segmented message may include a segmented message length field, the message portion, the CRC field, and optionally, the pad field. In some embodiments (e.g., when the flow moves from block 1106 to block 1110), the first network device contends for control of a contention-based communication slot for transmitting one or more segmented messages.

In another embodiment (e.g., when the flow moves from block 1108 to block 1110), the segmented messages are transmitted in contention-free communication slots previously allocated to the first network device. After transmitting a first segmented message in a contention-free communication slot, the first network device may only transmit related segmented messages in subsequent contention-free communication slots allocated to the first network device until all the segmented messages associated with the original message have been transmitted. A master network device may designate one or more of the contention-free communication slots (allocated to the first network device) for transmitting segmented messages. Thus the first network device may transmit segmented messages associated with the original message in those contention-free communication slots that have been allocated to the first network device for transmitting segmented messages. It is noted that once the first network device starts transmitting a segmented message, the first network device may complete transmitting the segmented message before starting to transmit another segmented message. Furthermore, once the first network device starts transmitting the segmented messages associated with an original message, the first network device may not transmit anew message until all the segmented messages associated with the original message have been transmitted. The flow continues at block 1112.

At block 1112, the first network device determines whether to transmit another segmented message. The flow loops back to block 1110 if there are additional segmented messages associated with the original message to be transmitted. The flow also loops back to block 1110 if the first network device received a notification indicating that one or more segmented messages were not successfully received at a receiving network device. The first network device determines that the original message was successfully transmitted after all the segmented messages (including re-transmissions) have been successfully acknowledged by the receiving network device(s). After all the segmented messages have been successfully transmitted, the flow ends.

FIG. 12 is a flow diagram 1200 illustrating example operations for receiving segmented messages. The flow 1200 begins at block 1202.

At block 1202, a first network device receives a first segmented message from a second network device in a first communication slot. The first network device may be a client network device in communication with a master network device or another client network device, or the first network device may be the master network device in communication with a client network device. Prior to receiving the first segmented message, the first network device may receive a management message from the second network device. The management message may indicate that subsequent messages transmitted by the second network device will be segmented messages, the total duration/length of the original message, and/or the number of segmented messages that will be transmitted. After transmitting the management message, the second network device may transmit the first segmented message in the next contention-free communication slot or in a contention-based communication slot. In some embodiments, instead of receiving a management message, the first segmented message indicates the total length of the original message and/or the number of subsequent segmented messages that will be transmitted. Additionally, one or more intermediate segmented messages may also indicate the total length of the original message and/or the number of subsequent segmented messages that will be transmitted if the first network device does not receive the first segmented message. The flow continues at block 1204.

At block 1204, the first network device determines a type of the first communication slot. The first network device may determine whether the first segmented message is received in a contention-free communication slot or a contention-based communication slot. As will be further described below, the first network device may use different techniques to determine in which communication slot the next segmented message will be transmitted depending on the type of the first communication slot. If the first communication slot is a contention-free communication slot, the flow continues at block 1206. Otherwise, if the first communication slot is a contention-based communication slot, the flow continues at block 1208.

At block 1206, if the first communication slot is a contention-free communication slot, the first network device determines a next communication slot for receiving a next segmented message based, at least in part, on a slot allocation schedule. For example, the first network device may receive the first segmented message from the second network device during a contention-free communication slot assigned to the second network device. Based on the slot allocation schedule, the first network device may determine in which communication slot subsequent segmented messages will be transmitted or retransmitted. The first network device may attempt to receive additional segmented messages during each subsequent contention-free communication slot assigned to the second network device for transmitting segmented messages. The flow continues at block 1210.

At block 1208, if the first communication slot is a contention-based communication slot, the first network device determines the next communication slot for receiving the next segmented message based, at least in part, on communications of the second network device. After receiving the first segmented message in a first contention-based communication slot, the first network device can monitor communications in another contention-based communication slot to determine whether the second network device gained control of a second contention-based communication slot. Referring to FIG. 10, the first network device may monitor communications in the contention interval 1004 to determine whether the second network device will transmit the next segmented message during the message transmission interval 1006 of the contention-based communication slot 1002. The first network device may use the slot allocation schedule to determine whether the second network device can contend for control of a contention-based communication slot. The slot allocation schedule may indicate the network devices and/or the contention group to which the contention-based communication slot is assigned. The first network device may monitor communications in the contention interval of these contention-based communication slots to determine when the second network device will transmit the next segmented message. The flow continues at block 1210.

At block 1210, the first network device receives the next segmented message in the next communication slot. The flow continues at block 1212.

At block 1212, the first network device determines whether a last (final) segmented message was received. The first network device may receive a message identified (by the second network device) as the last segmented message. The first network device may determine whether it has received that last segmented message based, at least in part, on sequence identifiers in each received segmented message and the number of segmented messages that will be transmitted. If the last segmented message was received, the flow continues at block 1214. If the last segmented message was not received, the flow continues at block 1218.

At block 1214, the first network device determines whether all the segmented messages were successfully received. As discussed above, the segmented messages that are transmitted in the contention-free communication slots may not include sequence identifiers that indicate the sequence of the segmented messages. Accordingly, the first network device can indirectly determine the sequence of the intermediate segmented messages based, at least in part, on the slot allocation schedule. The first network device may receive a message identified (by the second network device) as the first segmented message. The first network device may determine that the message received in the next contention-free communication slot allocated to the second network device is the second segmented message, the message received in the next contention-free communication slot allocated to the second network device is the third segmented message, and so on. The first network device may identify the first segmented message as segment 0, each of the intermediate segmented messages as segments 1 to (N−2), and the last segmented message as segment N−1. If the first network device does not receive a segmented message in a contention-free communication slot in which a segmented message was expected, the first network device may determine that a segment of the original message was not successfully received. The first network device may also determine which segment (e.g., whether the second segmented message, etc.) of the original message was not successfully received. For example, if the first network device does not receive a segmented message during the second contention-free communication slot allocated to the second network device, the first network device determines that segment 1 was not received.

As discussed above, the segmented messages that are transmitted in contention-based communication slots may include sequence identifiers. The first network device may maintain a record of the last sequence identifier received from the second network device. The first network device may use the last received sequence identifier to perform duplicate detection and filtering, and to determine which segments of the original message were not successfully received. If at least one segmented message was not successfully received at the first network device, the flow continues at block 1216. Otherwise, if all the segmented messages were received, the flow continues at block 1220.

At block 1216, if at least one segmented message was not successfully received, the first network device provides a retransmission request to the second network device. After the last (final) segmented message is received, the first network device can transmit a segmented message selective acknowledgement (SACK) to the second network device. The first network device may use the segment identifiers to indicate which segmented message(s) were not received or improperly received. The second network device can retransmit those segmented messages that were not successfully received by the first network device. The first network device can continue to transmit a segmented message SACK and receive one or more segmented message retransmissions until the first network device successfully receives all the segmented messages (i.e., the complete original message). The second network device can retransmit the segmented messages that were not properly received at the first network device in the proper sequence. For example, if the SACK indicates that the segments 1, 5, 8, and 10 were not properly received, the second network device retransmits the segments 1, 5, 8, and 10 in sequence one retransmitted segmented message per contention-free communication slot. This can allow the first network device to assign the appropriate segment identifier to the retransmitted segmented message. The flow continues at block 1218.

At block 1218, the first network device identifies a next communication slot for receiving a next segmented message. For example, the first network device identifies the next communication slot to receive an original transmission of a segmented message (e.g., when the flow moves from block 1212). As another example, the first network device identifies the next communication slot to receive a retransmission of a segmented message (e.g., when the flow moves from block 1216). If the first network device received segmented messages from the second network device in contention-free communication slots, the first network device can determine the next contention-free communication slot for receiving the next segmented message as similarly described above in block 1206. If the first network device received segmented messages from the second network device in contention-based communication slots, the first network device can determine the next contention-based communication slot for receiving the next segmented message as similarly described above in block 1208. The flow then loops back to block 1210 where the first network device attempts to receive the next segmented message in the identified communication slot.

At block 1220, if all the segmented messages were successfully received, the first network device assembles the segmented messages and reconstructs an original message. In one embodiment, the first network device assembles and reconstructs the original message from segmented messages received in the contention-free communication slots based, at least in part, on the slot allocation schedule. In another embodiment, the first network device assembles and reconstructs the original message from segmented messages received in the contention-based communication slots based, at least in part, on sequence identifiers associated with the segmented messages. From block 1220, the flow ends.

Repeating and relaying may be used to improve the probability that all network devices reliably receive and decode a message that is transmitted in the communication network. “Repeating” can refer to multiple transmissions of the same message by a network device that originally transmitted the message (“original transmitting network device”). Repeating can increase the probability that a receiving network device successfully receives at least one copy of the message. Repeating a message can also allow a receiving network device to use message recombining techniques to improve decoding reliability. Additionally, the original transmitting network device may retransmit a message in multiple communication slots to improve transmission reliability. “Relaying” can refer to the retransmitting a message that was previously received by a network device from another network device. Relaying can mitigate the effects of “hidden nodes” and marginal links. The network devices that are configured to retransmit messages received from the original transmitting network device may be referred to as “relay devices” or “repeater devices.” The relay devices may receive an original transmission of a message from the original transmitting network device. The relay devices may then retransmit the message in subsequent communication slots allocated to the original transmitting network device. The process by which the relay device and the original transmitting network device transmit the same message during the same communication slot may be referred to as “zero-overhead relaying.” Because the message being transmitted is the same, multiple copies of the message appear to the receiving network devices as multipath without hindering the ability of the receiving network device to decode the messages. Operations for relaying messages are further described in FIGS. 13 and 14.

FIG. 13 is a flow diagram 1300 illustrating example operations for relaying messages in a communication network. The flow 1300 begins at block 1302.

At block 1302, a first network device designated as a relay device receives a first message in a first communication slot. In some embodiments, the first network device receives a beacon message from a master network device of the communication network. In another embodiment, the first network device receives a management message, a short message (e.g., including data that is less than 12 bytes long), or another suitable type of message from a second network device. The master network device may designate the first network device as a relay device depending on the position of the first network device in the communication network, the performance of communication links between various network devices in the communication network, etc. The first network device may be configured to relay only certain messages, such as messages that originate from a specified network device, messages that are received in a certain type of communication slot, and/or a specific type of message. The flow continues at block 1304.

At block 1304, the first network device determines a type of the first communication slot. The first network device may execute different operations depending on whether the message is received in a contention-free communication slot (e.g., a CFA communication slot) or a contention-based communication slot (e.g., a CFCA communication slot or a RPCA communication slot) as will be described below. The flow continues at block 1306 if the first message is received in a contention-free communication slot. The flow continues at block 1310 if the first message was received in a contention-based communication slot.

At block 1306, if the first communication slot is a contention-free communication slot, the first network device determines whether the first message was successfully received. The first network device may decode and decrypt the first message, and verify the CRC in the decoded and decrypted message. The master network device may provide the first network device with the encryption keys that can be used to decrypt the messages relayed by the first network device. If the CRC is valid, this can indicate that the first network device successfully decoded and decrypted the first message. However, if the first network device does not have the encryption key to decrypt the first message, the first network device may be unable to validate the CRC of the first message. The first network device may use a suitable decoder (e.g., a turbo forward error correction (FEC) decoder) to check for errors in time first message. If the decoder has converged to a valid codeword, the first network device may determine that the first message was successfully received. If the first message was successfully received, the flow continues at block 1308. Otherwise, the first network device discards the first message and the flow ends.

At block 1308, if the first message was successfully received, the first network device determines a second communication slot for relaying the first message based, at least in part, on a slot allocation schedule. Both the relay device and the original transmitting network device may retransmit the first message in one or more communication slots allocated to the original transmitting network device. For example, these communication slots are contention-free communication slots assigned by the master network device to the original transmitting network device. In another example, these communication slots are contention-based communication slots that the original transmitting network device gained control after executing priority contention operations. To allow a receiving network device to combine multiple copies of the same message (“receive combining” or “copy combining”), the original message and the retransmissions may not differ from each other. In some embodiments, the first network device determines when to retransmit the first message based, at least in part, on the contention-free communication slots assigned to the original transmitting network device. The first network device may determine how many times to retransmit the first message based, at least in part, on registration information provided by the master network device, information in the slot allocation schedule, and/or an indication in the first message. The first network device may retransmit the first message in the subsequent contention-free communication slots that are allocated to the original transmitting network device (indicated in the slot allocation schedule).

The slot allocation schedule may indicate which contention-free communication slots should be used for retransmission. For example, the master network device may allocate three contention-free communication slots to the original transmitting network device for retransmitting an original message that is transmitted in a contention-free communication slot. In response to receiving the first message, the first network device may identify the communication slots for retransmitting the first message based, at least in part, on the slot allocation schedule. The first network device may also use the slot allocation schedule to determine whether a received message is a retransmission of the first message. The flow continues at block 1312.

At block 1310, if the first message is received in a contention-based communication slot, the first network device determines a second communication slot based, at least in part, on transmissions in a contention interval. In some embodiments, the first network device belongs to the same CFCA contention group as the original transmitting network device. In another embodiment, the first network device is designated (e.g., by the master network device) to relay the transmissions of the original transmitting network device. The original transmitting network device may contend for control of a contention-based communication slot and transmit the first message. The original transmitting network device may be configured to retransmit the first message a predetermined number of times. For each of the predetermined number of times, the original transmitting network device may contend for control of another contention-based communication slot and retransmit the first message once it gains control of the next contention-based communication slot.

After receiving the first message from the original transmitting network device, the first network device may monitor communications in the contention interval for the contention-based communication slots. The contention-based communication slots may be CFCA communication slots allocated to the CFCA contention group or RPCA communication slots identified in a beacon message. If the first network device determines that the original transmitting network device gained control of the second contention-based communication slot, the first network device can retransmit the first message in the second contention-based communication slot. The original transmitting network device may not transmit a new message until a predetermined number of retransmissions of the first message have been completed. Therefore, the first network device may retransmit the first message in a predetermined number of contention-based communication slots that the original transmitting network device gains control. The first network device may determine how many times to retransmit the first message based, at least in part, on registration information provided by the master network device, information in the slot allocation schedule, and/or an indication in the first message.

One or more CFA communication slots and/or OVA communication slots may be used for relaying/repeating the messages originally transmitted in the RPCA communication slot. For example, the second communication slot may be a contention-free communication slot that is assigned by the master network device to the original transmitting network device for retransmitting the first message. As another example, the second communication slot may be a contention-based communication slot that the original transmitting network device gained control after executing priority contention operations. The flow continues at block 1312.

At block 1312, the first network device retransmits the first message in the second communication slot. From block 1312, the flow ends.

FIG. 13 describes the relay device and the original transmitting network device retransmitting the original message the same number of times. In other embodiments, the relay device retransmits the original message a fewer number of times as compared to the original transmitting network device. For example, the relay device may not successfully receive the original message during a first communication slot (e.g., contention-free communication slot or contention-based communication slot). Instead, the first network device may successfully receive the first retransmission from the original transmitting network device in a second communication slot; and may relay the message during a third communication slot allocated to the original transmitting network device. As another example, the original transmitting network device may transmit the original message three times (e.g., one original transmission and two retransmissions); while the relay device may retransmit the message only once. For example, if three contention-free communication slots are allocated to the original transmitting network device for transmitting the message, the relay device may retransmit the message during the third contention-free communication slot that is allocated to the original transmitting network device.

FIG. 13 describes the relay device performing CRC verification prior to relaying the message when the message is received in a contention-free communication slot. In other embodiments the relay device performs CRC verification when the message is received in a contention-based communication slots as well.

FIG. 14 is an example conceptual diagram illustrating an original transmission and retransmissions by relay devices. FIG. 14 depicts a graph of the transmissions and retransmissions (Y-axis) in various communication slots during a period of time (X-axis). In FIG. 14, the original transmitting network device transmits original message 1402A during communication slot 1404 assigned to the original transmitting network device. A first relay device and a second relay device receive the message 1402A. In some embodiments, the first and the second relay devices decrypt the message 1402A, verify the CRC, undue-encrypt the message if the CRC is valid. As depicted in FIG. 14, the original transmitting network device retransmits the message 1402B during the next communication slot 1406. In some embodiments, the communication slot 1406 is a contention-free communication slot that is allocated to the original transmitting network device. In other embodiments, the communication slot 1406 is a contention-based communication slot that the original transmitting network device gained control after priority resolution. The first and the second relay devices transmit messages 1402C and 1402D respectively, during the communication slot 1406. The original transmitting network device, the first relay device, and the second relay device can use timing derived from the beacon period (e.g., communication slots allocated by the master network device) to determine when to transmit the messages 1402B, 1402C, and 1402D. For example, the first and the second relay devices determine the communication slot 1406 that is assigned to the original transmitting network device from a retransmission schedule (or a slot allocation schedule) received from the master network device. Thus, the relay devices may simultaneously retransmit the message during the same communication slot when the original transmitting network device retransmits the message. It is noted that the first and the second relay devices transmitting messages 1402C and 1402D respectively, may also be referred to as the first and the second relay devices retransmitting (or repeating) the original message (e.g., message 1402A).

A receiving network device may also use the retransmission schedule received from the master network device to reliably receive and decode a message. The receiving network device may use the slot allocation schedule to determine one or more communication slots (e.g., the communication slots 1404 and 1406) allocated to the original transmitting network device to receive the original transmission and the retransmissions of the message. Because the content of the messages 1402A, 1402B, 1402C, and 1402D are the same, other network devices may reliably receive the message (without collisions) if they detect the original message 1402A and/or the retransmitted messages 1402B, 1402C, and 1402D. A relay device may miss the first transmission of the message 1402A from the original transmitting network device. The relay device may detect a second transmission (also referred to as a first retransmission) of the message 1402B from the original transmitting network device. Accordingly, the message may include a repetition count field that indicates how many times the message will be retransmitted. The original transmitting network device may decrement the value in the repetition count field at each retransmission. The relay device may use the value in the repetition count field to retransmit the message received from the original transmitting network device the appropriate number of times. Furthermore, the relay device may also decrement the value in the repetition count field at each retransmission so that the content of the message that is retransmitted by the original transmitting network device is the same as the content of the message retransmitted by the relay device.

In some embodiments, repeating/relaying is supported only in a subset of the communication slots. An original transmitting network device may retransmit an original message only in a first subset of contention-free communication slots that are allocated for retransmitting/relaying the original message. The original transmitting network device may transmit other messages (not retransmissions) in the remaining contention-free communication slots assigned to the network device. Likewise, the relay devices may retransmit the original message received from the network device only during the first subset of contention-free communication slots assigned to the original transmitting network device. The contention-free communication slots that are allocated for retransmitting an original message may be referred to as a “CFA transmission group,” For example, a first contention-free communication slot may be allocated to an original transmitting network device for transmitting an original message. A second and third contention-free communication slots may be allocated to the original transmitting network device for two retransmissions of the original message. The first, second, and third contention-free communication slots may collectively be referred to as a CFA transmission group and may be indicated in the slot allocation schedule. The relay device may determine whether/when to retransmit a message received in a contention-free communication slot based, at least in part, on the CFA transmission group. As another example, the original transmitting network device may retransmit an original message only when it gains control of a communication slot within a first subset of the contention-based communication slots that support retransmission/relaying. The original transmitting network device may transmit other messages (not retransmissions) if it gains control of a communication slot that does not belong to the first subset. Likewise, the relay devices may retransmit the original message only when the original transmitting network device gains control of a communication slot within the first subset.

A receiving network device may use the CFA transmission group to receive multiple copies of the original message and to perform copy combining. For example, the receiving network device may receive the original message (or a portion of the original message) during a first contention-free communication slot. Based on the slot allocation schedule, the receiving network device may identify subsequent contention-free communication slots that belong to the same CFA transmission group as the first contention-free communication slot. Referring to the example of FIG. 8, if the receiving network device receives an original message during communication slot 8 of the 0-2 ms sub-interval, the receiving network device may determine that communication slots 8 of the 4-6 ms sub-interval and the 10-12 ms sub-interval belong to the same CFA transmission group. The receiving network device may attempt to receive retransmissions of the original message (e.g., from the original transmitting network device, from one or more relay devices, etc.) during these communication slots. The original transmitting network device and the relay device may generate the messages so that the original message and the retransmitted messages do not differ from each other. For example, the original message and the retransmitted messages may not include a distinct field indicating that whether the message is a retransmission. Because the original message and the retransmitted messages do not differ from each other, they may appear as multipath to the receiving network device. The receiving network device may use the communication slots that belong to the same CFA transmission group to receive the original message and the retransmitted messages. The receiving network device may combine the original message and/or the retransmitted messages to properly decode and process the message.

A relay device may also be used for “self-healing” the communication network. For example, a relay device may be used to route/retransmit a message in the communication network if some channels degrade during normal operation, aging, or failure.

The master network device may designate one or more of the client network devices as beacon relay devices. The beacon relay devices may retransmit received beacon messages in communication slots assigned for relaying beacon messages (“beacon retransmission slots”). In response to receiving a beacon message, a beacon relay device may identify other beacon retransmission slots within the same beacon period from the slot allocation schedule. The beacon relay device and/or the master network device may retransmit the beacon message during one or more of the beacon retransmission slots. A beacon slot identifier may be updated in the repeated/relayed beacon messages so that the receiving network devices can determine the start of the beacon period. The beacon relay device may update the beacon slot identifier in the beacon message and recalculate the CRC before re-transmitting the beacon message. Furthermore, network devices that cannot reliably receive the beacon message transmitted by the master network device may use the relayed beacon message to synchronize their PHY clocks to the PITY clock of the master network device.

The master network device may designate one or more of the client network devices as registration relay devices. The registration relay devices may include those client network devices that can reliably communicate with the master network device. The master network device may also allocate one or more communication slots for relaying registration requests. A registration relay device may detect a registration request transmitted by an unregistered client network device. The registration relay device may retransmit the registration request during the allocated communication slot. If a contention-based communication slot is allocated for retransmitting registration requests, the registration relay device may retransmit the registration request (originally transmitted by the unregistered client network device) after gaining control of the contention-based communication slot. Alternatively, a contention-free communication slot may be allocated for relaying the registration request. The master network device may also allocate one or more contention-free or contention-based communication slots for relaying registration responses. As similarly described above, the registration relay device may detect a registration response transmitted by the master network device. The registration relay device may retransmit the registration response during the allocated communication slot.

When a message is repeated and relayed in the communication network, a receiving network device may receive more than one copy of the same message (e.g., MPDU). Duplicate messages can be detected and discarded depending on the medium access technique employed. For messages that were transmitted in contention-free communication slots, a receiving network device can determine when duplicate message transmissions may occur based, at least in part, on the slot allocation schedule. The slot allocation schedule may identify the contention-free communication slots that are assigned to the same transmitting network device and that are part of the same CFA transmission group. The receiving network device may determine that duplicate message transmissions can occur during contention-free communication slots that belong to the same CFA transmission group. The receiving network device can keep track of the messages that are received during the contention-free communication slots that belong to the same CFA transmission group and determine whether duplicate messages were received. For example, the receiving network device may compare one or more fields of a first message received in a first communication slot of the CFA transmission group against corresponding fields of a second message received in a second communication slot of the same CFA transmission group. As another example, if the most recently received message was received in a communication slot that belongs to a different CFA transmission group, the receiving network device may determine that the received message is not a duplicate.

For messages that were transmitted in contention-based communication slots (e.g., using CFCA or RPCA), sequence identifiers can be used to detect and filter duplicates. A receiving network device can maintain a record of the last sequence identifier received from each transmitting network device in the communication network. The receiving network device may discard a received message if the sequence identifier of the received message is the same as a last received sequence identifier for a particular transmitting network device.

Various techniques for duplicate detection and filtering may also be employed depending on the message format that is used to transmit the message. For example, messages that are generated using the message ID MPDU format 650 may include a sequence identifier for detecting and discarding duplicate messages. As another example, messages that are generated using the TEI MPDU format 680 may or may not include sequence identifiers. 117 the message in the TEI MPDU format 680 includes a sequence identifier field, then the sequence identifiers can be used to detect and discard duplicate messages. However, if the message in the TEI MPDU format 680 does not include the sequence identifier field, then duplicate detection operations may not be executed. In some embodiments, the message in the TEI MPDU format 680 is not transmitted, relayed, or repeated in the contention-based communication slots if the message does not include the sequence identifier field. In other embodiments, the message in the TEI MPDU format 680 is transmitted in the contention-based communication slots without the sequence identifier if the application layer can detect duplicate messages.

It should be understood that FIGS. 1-14 are examples meant to aid in understanding embodiments and should not be used to limit embodiments or limit scope of the claims. Embodiments may comprise additional circuit components, different circuit components, and/or may perform additional operations, fewer operations, operations in a different order, operations in parallel, and some operations differently. Although examples describe operations for registration and allocating communication slots for communication, relay, and segmentation in a PLC environment; in other embodiments, the operations described herein may be extended to other communication networks and communication protocols. For example, the operations for registration, allocating communication slots, transmitting a message, segmenting a message, and/or relaying a message may be executed by network devices that implement WLAN communication protocols (e.g., IEEE 802.11 communication protocols), MoCA communication protocols, Ethernet communication protocols, G.hn home networking protocols, and so on. In other embodiments, the operations described above may be extended to a combination of communication protocols, such as a combination of PLC protocols and WLAN communication protocols.

A network device that does not support communication using S-MAP (e.g., a device that is unable to transmit or receive PLC-AB traffic) may be referred to as a “legacy device” or “legacy network device.” Legacy devices may implement conventional HomePlug AV/AV2/GreenPHY communication protocols. A network device that operates using S-MAP and that can transmit/receive PLC-AB traffic may be referred to as a “non-legacy device” or “non-legacy network device.” The master network device and the client network devices described above with reference to FIGS. 1-14 may be non-legacy devices that implement S-MAP. The length of the CRC field in the message formats used by the non-legacy devices (“non-legacy frame format”) may be different from the length of the CRC field in the message formats used by the legacy devices (“legacy frame format”). For example, the legacy frame format includes a 24-bit CRC field, while the non-legacy frame format (e.g., the TEI MPDU format 680 or the message ID MPDU format 650) includes a 32-bit CRC field. Thus, legacy devices may be unable to decode the messages transmitted by the non-legacy devices. In some embodiments, a non-legacy device may support a legacy variant format in addition to the message ID MPDU format 650 and the TEI MPDU format 680. The legacy variant format may allow the non-legacy devices to communicate with the legacy devices for backwards compatibility. The legacy variant format may be similar to the TEI MPDU format 680. For example, all the fields in a message generated using the legacy variant format may be unencrypted. The last 24 bits of the 32-bit CRC field of a message in the TEI MPDU format 680 may be replaced by an inverted (or non-inverted) 24-bit CRC value. Whether the 24-bit CRC value is inverted may depend on the legacy PLC protocol supported by the legacy device. Thus, the 32-bit CRC field of the non-legacy frame format may include an 8-bit most significant bit (MSB) from the 32-bit CRC value originally generated by the non-legacy device and a 24-bit CRC value for backwards compatibility with legacy devices. A receiving legacy device may validate the 24-bit CRC value using the legacy PLC protocol.

The non-legacy devices may implement techniques for coexistence with legacy devices in a home network, such as a legacy HomePlug network. In some embodiments, the non-legacy devices may implement carrier sense multiple access (CSMA) contention to gain control of the communication medium when legacy devices are detected on the communication medium. If a non-legacy device gains control of the communication medium, the legacy devices back-off and relinquish control of the communication medium to the non-legacy device. The legacy devices may resume contending for control of the communication medium after the non-legacy messages are transmitted. Additionally, because messages transmitted by the non-legacy device (“non-legacy message”) have a different format as compared to the messages transmitted by legacy devices (“legacy message”), the legacy device may be unable to receive/decode the non-legacy messages. For example, CRC validation operations fail when the legacy device receives a 32-bit CRC value in the non-legacy message instead of receiving a 24-bit CRC value in the legacy message. As another example, the CRC validation operations fail when the legacy device tries to process messages where the entire message including the CRC field is encrypted. When the CRC validation operations fail at the legacy device, the legacy device may consider the non-legacy message to be noise. The legacy device may resume contending for the communication medium after the CRC validation operations fail without affecting the operations of the non-legacy devices.

In other embodiments, the non-legacy devices transmit request-to-send (RTS) and clear-to-send (CTS) messages to reserve time on the communication medium when legacy devices are detected on the communication medium. The non-legacy device may transmit the RTS message including a message transmission interval (e.g., an indication of how long the communication medium will be in use). After receiving CTS messages from the legacy devices on the communication medium, the non-legacy device may transmit one or more non-legacy messages that are generated using the message formats shown in FIG. 6B or 6C. The message transmission interval may account for the time to transmit the non-legacy messages, retransmit/relay the non-legacy messages, receive acknowledgement messages, etc.

A legacy device may be coupled with a communication network that supports non-legacy devices and messages. For example, a plug-and-play module may be connected to a convenience outlet and consequently, the automotive bus) of a vehicle. The legacy device may receive a firmware upgrade from the master network device to operate on the automotive bus. By applying the firmware upgrade, the legacy device may support transmission/reception of PLC-AB messages, transmission in assigned or contention-based TDMA communication slots, and various other techniques described above. After the firmware upgrade, the legacy device may generate a message using the message format shown in FIG. 6B or 6C and may transmit the message during a communication slot assigned to the legacy device. The legacy device may receive the firmware upgrade during a manufacturing process. After the upgrade, the legacy device may include legacy circuitry with the updated firmware. When connected to the automotive bus, the master network device may detect the presence of the legacy device with the updated firmware. The legacy device may be allocated multiple contiguous communication slots that are sufficiently large to transmit longer legacy packet formats (e.g., packets using HomePlug AV/AV2/GreenPHY). The communication slots allocated to the legacy device may be contention-free communication slots or contention-based communication slots.

As described above, the vehicle 200 of FIG. 2 may be an electric vehicle and may be coupled with a charging station (not shown). The charging station may include one or more network devices configured similarly to the network device 102 of FIG. 1. The network devices of the electric vehicle and the charging station may use S-MAP for communications between the electric vehicle and the charging station during assigned communication slots. For example, the network devices may exchange messages between the electric vehicle and the charging station for health and status information, command/control information, billing information, etc. The network devices within the electric vehicle may form a first internal PLC network, such as a first internal HomePlug AV network. Likewise, network devices within the charging station may form a second internal PLC network, such as a second internal HomePlug AV network. The network devices of the electric vehicle and the network devices of the charging station may form a third. PLC network when the electric vehicle is connected to for plugged into) the charging station.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module,” “unit,” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-atone software package, partly on the user's computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

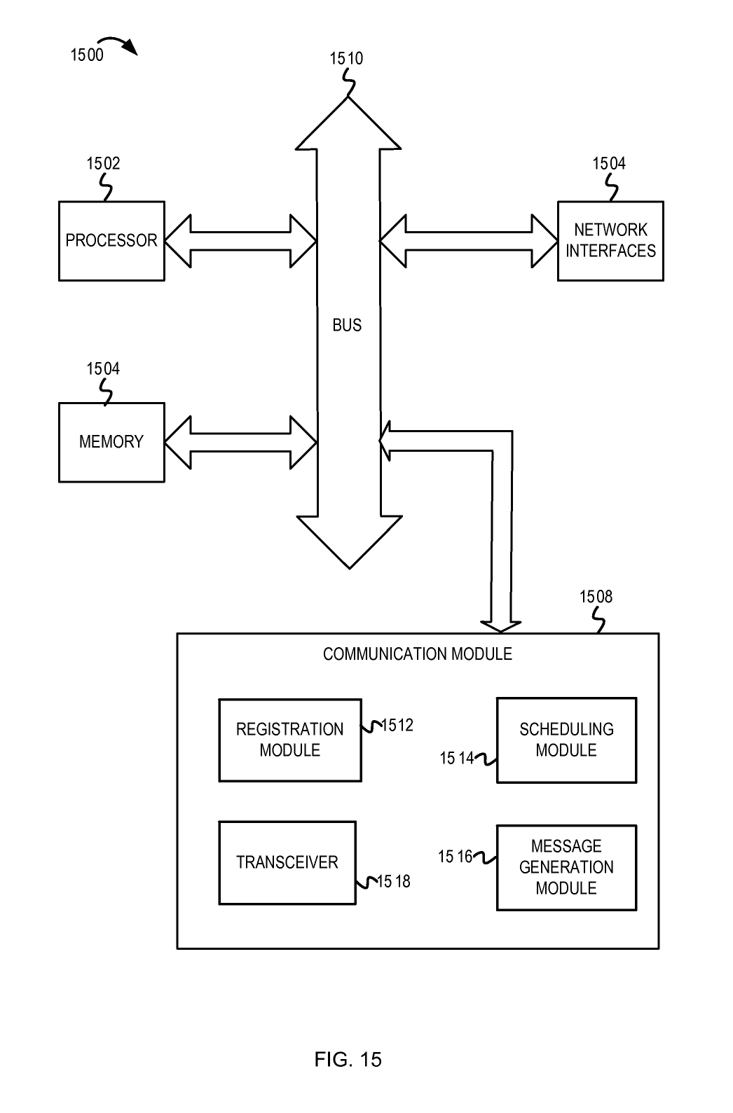

FIG. 15 is a block diagram of one embodiment of an electronic device 1500 including a slot allocation mechanism for transmitting messages. In some embodiments, the electronic device 1500 is a communication component within a system, such as a plug-in electric vehicle (PEV), a hybrid electric vehicle, a gas-powered vehicle, an electric vehicle supply equipment (EVSE or charging station), an aircraft, electronic machinery, or another system with communication capabilities. In another embodiment, the electronic device 1500 is a desktop computer, a laptop computer, a tablet computer, a mobile phone, a smart appliance, a PLC device, a gaming console, a network bridging device, an access point, an electric vehicle, a gas-powered vehicle, a charging station, or other electronic device with communication capabilities. The electronic device 1500 includes a processor 1502 which can include multiple processors, multiple cores, multiple nodes, and/or implementing multi-threading, etc. The electronic device 1500 includes a memory 1506. The memory 1506 may be system memory (e.g., one or more of cache, SRAM, DRAM, zero capacitor RAM, Twin Transistor RAM, eDRAM, EDO RAM, DDR RAM, EEPROM, NRAM, RRAM, Silicon-Oxide-Nitride-Oxide-Silicon (SONOS), PRAM, etc.) or any one or more of the above already described possible realizations of computer-readable storage media. The electronic device 1500 also includes a bus 1510 (e.g., Peripheral Component Interconnect (PCI), Industry Standard Architecture (ISA), PCI-Express, HyperTransport®, InfiniBand®, NuBus, Advanced High-performance Bus (AHB), Advanced eXtensible Interface (AXI), etc.), and network interface 1504 that include at least one of a wireless network interface (e.g., a WLAN interface, a Bluetooth® interface, a WiMAX interface, a ZigBee® interface, a Wireless USB interface, etc.) and a wired network interface (e.g., a PLC interface, an Ethernet interface, etc.). The processor 1502, the memory 1506, and the network interface 1504 are coupled to the bus 1510.

The electronic device 1500 also includes a communication module 1508. The communication module 1508 includes a registration module 1512, a scheduling module 1514, a message generation module 1516, and a transceiver 1518. The registration module 1512 may execute operations to register a network device in the communication network, as described above with reference to FIGS. 3-5. The scheduling module 1514 may allocate communication slots for contention-free access and/or contention-based access of the communication medium as described above in FIGS. 7-10. The scheduling module 1514 may contend with other network devices for control of a contention-based communication slot, as described above with reference to FIGS. 9 and 10. The message generation module 1516 may generate the message using a suitable message format as described in FIGS. 6A-6C. The message generation module 1516 may generate two or more segmented messages from an original message for transmission (if needed). The message generation module 1516 may also reconstruct the original message from received segmented messages as described above in FIGS. 11 and 12. Additionally, if configured as a relay device, the scheduling module 1514 may retransmit messages received from an original transmitting network device as described above with reference to FIGS. 13 and 14. The transceiver 1518 may include a receiver and a transmitter as described above with reference to FIG. 1. In some embodiments, the transceiver 1518 is implemented as part of the network interface 1504. In other embodiments, the transceiver 1518 is implemented separate from the network interface 1504 or the communication module 1508 and may be coupled with the bus 1510.

Any one of these functionalities may be partially (or entirely) implemented in hardware and/or on the processor 1502. For example, the functionality may be implemented with a system-on-a-chip (SoC), an application specific integrated circuit (ASIC), logic implemented in the processor 1502, in a co-processor on a peripheral device or card, etc. Further, realizations may include fewer or additional components not illustrated in FIG. 15 (e.g., video cards, audio cards, additional network interfaces, peripheral devices, etc.). For example, in addition to the processor 1502 coupled with the bus 1510, the communication module 1508 may include at least one additional processor. As another example, the communication module 1508 may include one or more radio transceivers, processors, memory, and other logic to implement the communication protocols and related functionality. As another example, although illustrated as being coupled to the bus 1510, the memory 1506 may be coupled to the processor 1502.

While the embodiments are described with reference to various implementations and exploitations, it will be understood that these embodiments are illustrative and that the scope of the disclosure is not limited to them. In general, slot allocation techniques for transmitting messages in a communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fail within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method for network device registration, the method comprising:
determining, at a first network device of a communication network, to register a second network device in the communication network;
determining, at the first network device, a location of the second network device in the communication network based, at least in part, on a first message received from the second network device; and
determining first registration information for the second network device based, at least in part, on the location of the second network device.

2. The method of claim 1, wherein determining the first registration information is further based, at least in part, on device information associated with the second network device.

3. The method of claim 1, further comprising:
determining that first device information received from the second network device is the same as second device information received from a third network device of the communication network; and
determining the location of the second network device in response to determining that the first device information is the same as the second device information.

4. The method of claim 1, wherein determining to register the second network device comprises:
receiving, from the second network device, a registration request including a first temporary identifier of the second network device;
determining a second temporary identifier and a first communication slot for the second network device based, at least in part, on the first temporary identifier, wherein the first communication slot is one of a plurality of communication slots of a beacon period; and
assigning the second temporary identifier and the first communication slot to the second network device for registering the second network device.

5. The method of claim 4, further comprising:
transmitting a key exchange message during the first communication slot assigned to the second network device to determine a device encryption key associated with the second network device, the key exchange message including the second temporary identifier associated with the second network device, the device encryption key to be used for unicast communications between the first network device and the second network device.

6. The method of claim 1, further comprising:
transmitting the first registration information to the second network device, the first registration information to be used tier subsequent communications between the first network device and the second network device.

7. The method of claim 1, further comprising:
determining to register a third network device in the communication network;
determining that first device information received from the second network device is the same as second device information received from the third network device;
determining the location of the second network device and a location of the third network device in response to determining the first device information is the same as the second device information;
determining the first registration information associated with the second network device based, at least in part, on the location of the second network device; and
determining second registration information associated with the third network device based, at least in part, on the location of the third network device.

8. The method of claim 1, further comprising:
determining first channel characteristics based, at least in part, on the first message received from the second network device,
wherein determining the location of the second network device is based, at least in part, on the first channel characteristics.

9. The method of claim 1, wherein determining the location of the second network device further comprises:
transmitting a request to the second network device to broadcast the first message in the communication network;
determining first channel characteristics based, at least in part, on the first message received from the second network device;
receiving second channel characteristics from a third network device that also received the first message from the second network device; and
estimating the location of the second network device based; at least in part, on the first channel characteristics and the second channel characteristics.

10. The method of claim 1, wherein determining the location of the second network device further comprises:
causing a third network device to short a powerline wiring of the communication network or to apply a load to the powerline wiring;
transmitting a request to the second network device to broadcast the first message in the communication network in response to the third network device shorting the powerline wiring or applying the load to the powerline wiring;
determining first channel characteristics based, at least in part, on the first message received from the second network device; and
estimating the location of the second network device in the communication network based, at least in part, on the first channel characteristics.

11. The method of claim 1, wherein the first message received from the second network device includes an indication of the location of the second network device.

12. The method of claim 1, further comprising:
receiving an indication of the location of the second network device from the second network device in the first message, wherein a section of a powerline wiring of the communication network coupled with the second network device includes at least one component to be used to determine the location of the second network device.

13. The method of claim 1, wherein the first registration information includes at east one member selected from the group consisting of:
a device identifier associated with the second network device,
a device encryption key associated with the second network device,
a contention-free communication slot assigned to the second network device,
a contention group associated with the second network device and at least one contention-based communication slot assigned to the contention group,
a slot allocation schedule indicating a plurality of communication slots that are allocated to a plurality of network devices of the communication network,
a group encryption key associated with the second network device and at least a third network device of the communication network,
the location of the second network device, and
an indication of whether the second network device is a relay device.

14. The method of claim 1, further comprising:
generating a second message for reception by a legacy network device, the second message including a CRC field with a first number of bits;
replacing a subset of the first number of bits by a second number of bits, wherein the second number of bits are added for reception by the legacy network device; and
transmitting the second message, wherein the CRC field of the second message includes a remainder of the first number of bits followed by the second number of bits.

15. The method of claim 1, further comprising:
allocating a first communication slot of a plurality of communication slots of a beacon period to the second network device based, at least in part, on transmission information received from the second network device,
wherein the first registration information includes an indication of the first communication slot allocated to the second network device.

16. The method of claim 15, further comprising:
allocating a second communication slot to the second network device for retransmission of a message transmitted in the first communication slot, wherein the first registration information indicates that the second communication slot is allocated for retransmission.

17. The method of claim 1, further comprising:
determining to transmit a second message in a first communication slot allocated to the first network device, the second message having a first message format, wherein the second message includes an indication of the first message format in a cyclic redundancy check (CRC) field of the second message.

18. The method of claim 1, further comprising:
forming a first segmented message and a second segmented message from a second message in response to determining that the second message exceeds a threshold message length;
determining to transmit the first segmented message in a first communication slot and the second segmented message in a second communication slot, wherein the first communication slot and the second communication slot are contention-based communication slots allocated to the first network device; and
determining to include a first sequence identifier in the first segmented message and a second sequence identifier in the second segmented message when the first communication slot and the second communication slot are contention-based communication slots.

19. The method of claim 1, further comprising:
forming a first segmented message and a second segmented message from a second message in response to determining that the second message exceeds a threshold message length;
determining to transmit the first segmented message in a first communication slot and the second segmented message in a second communication slot, wherein the first communication slot and the second communication slot are contention-free communication slots allocated to the first network device; and
determining not to include a sequence identifier in the first segmented message and in the second segmented message when the first communication slot and the second communication slot are contention-free communication slots.

20. The method of claim 1, further comprising:
receiving, from a third network device of the communication network, a first segmented message in a first communication slot;
determining that the first communication slot is a contention-free communication slot allocated to the third network device; and
identifying a second communication slot for receiving a second segmented message from the third network device based, at least in part, on a slot allocation schedule that indicates a plurality of communication slots that are allocated to a plurality of network devices of the communication network, wherein the second communication slot is a contention-free communication slot allocated to the third network device.

21. The method of claim 1, further comprising:
receiving, at the first network device, a second message from the second network device during a first communication slot allocated to the second network device;
determining that the first network device is a relay device for the second network device; and
in response to determining that the first communication slot is a contention-free communication slot,
determining to retransmit the second message in a second communication slot based, at least in part, on a slot allocation schedule that indicates a plurality of communication slots that are allocated to a plurality of network devices of the communication network, wherein the second communication slot is a contention-free communication slot.

22. The method of claim 1, further comprising:
receiving, at the first network device, a second message from the second network device during a first communication slot allocated to the second network device;
determining that the first network device is a relay device for the second network device; and
in response to determining that the first communication slot is a contention-based communication slot,
determining to retransmit the second message in a second communication slot based, at least in part, on determining that the second network device has gained control of the second communication slot, wherein the second communication slot is a contention-based communication slot.

23. The method of claim 1, wherein the first network device and the second network device are included in the communication network of a vehicle.

24. A first network device comprising:
a processor; and
a memory to store instructions that, when executed by the processor, cause the first network device to:
determine to register a second network device in a communication network;
determine a location of the second network device in the communication network based, at least in part, on a first message received from the second network device; and
determine registration information for the second network device based, at least in part, on the location of the second network device in the communication network.

25. The first network device of claim 24, further comprising instructions that, when executed by the processor, cause the first network device to:
receive, from the second network device, a registration request including a first temporary identifier of the second network device;
determine a second temporary identifier and a first communication slot for the second network device based, at least in part, on the first temporary identifier, wherein the first communication slot is one of a plurality of communication slots of a beacon period; and
assigning the second temporary identifier and the first communication slot to the second network device for registering the second network device.

26. A non-transitory machine-readable storage medium having machine executable instructions stored therein, the machine executable instructions comprising instructions to:
determine, at a first network device of a communication network, to register a second network device in the communication network;
determine, at the first network device, a location of the second network device in the communication network based, at least in part, on a first message received from the second network device; and
determine registration information for the second network device based, at least in part, on the location of the second network device in the communication network.

27. The non-transitory machine-readable storage medium of claim 26, wherein said instructions to determine the location of the second network device comprise instructions to:
transmit a request to the second network device to broadcast the first message in the communication network;
determine first channel characteristics based, at least in part, on the first message received from the second network device;
receive second channel characteristics from a third network device that also received the first message from the second network device; and
estimate the location of the second network device based, at least in part, on the first channel characteristics and the second channel characteristics.

28. A method for network device registration, the method comprising:
determining, by a first network device of a communication network, to register a second network device in the communication network based, at least part, on receiving a registration request from the second network device;
allocating, by the first network device, a temporary identifier and a first communication slot to the second network device to register the second network device, wherein the first communication slot is one of a plurality of communication slots of a beacon period;
receiving a registration message from the second network device during the first communication slot, the registration message including the temporary identifier associated with the second network device; and
determining registration information associated with the second ne work device based, at least in part, on the registration message.

29. The method of claim 28, wherein determining the registration information comprises determining a device identifier and a second communication slot of the plurality of communication slots for the second network device to transmit messages in the communication network.

30. The method of claim 28, further comprising:
deallocating the temporary identifier and the first communication slot in response to registering the second network device in the communication network; and
transmitting subsequent messages in the communication network based, at least in part, on the registration information, the registration information indicating a device identifier and a second communication slot of the plurality of communication slots that the first network device allocated to the second network device.
